(19) United States
(12) Patent Application Publication
(10) Pub. No.: US 2025/0007328 A1
(43) Pub. Date: Jan. 2, 2025

(54) A WIRELESS POWER TRANSFER APPARATUS

(71) Applicant: Auckland UniServices Limited, Auckland (NZ)

(72) Inventors: Udaya Kumara MADAWALA, Auckland (NZ); Meilin HU, Hubei (CN); Zhongzheng LIN, Sichuan (CN)

(21) Appl. No.: 18/709,704

(22) PCT Filed: Nov. 21, 2022
(86) PCT No.: PCT/IB2022/061242

§ 371 Date: May 13, 2024

(30) Foreign Application Priority Data
Nov. 19, 2021 (NZ) 782521

(51) Int. Cl. H02J 50/12; B60L 53/122; H02J 50/70

(52) U.S. Cl. CPC H02J 50/12; B60L 53/122; H02J 50/70

(57) ABSTRACT

A wireless power transfer coupling apparatus, comprising: at least one conductive member configured as a layer of the first coupling member to provide a magnetic field for wireless power transfer, the conductive member having: a first end; and a second end opposite the first end, wherein: the conductive member extends from the first end to the second end along a lengthwise axis of the coupling apparatus and is configured to distribute current across the layer between the first and second ends. The conductive member comprising a layer of permeable material that extends on the either side to form pole area and further extending in a direction toward a magnetic flux coupling region. The wireless power transfer apparatus further comprising an uncompensated primary coupler and a capacitor compensated secondary that compensates the reactance of the primary coupler by a reflected impedance.

### FIELD OF THE INVENTION

The present invention relates to wireless power transfer systems and includes an inductive power transfer magnetic structure configuration and control for the use in wireless charging of devices and vehicles.

### BACKGROUND

Wireless power transfer (WPT) can provide a convenient and robust alternative to conventional physical connectors and electrical wiring. Some applications for wireless power transfer include recharging portable consumer devices (such as watches and mobile phones), delivering power to industrial sensors and/or actuators across moving junctions, charging implanted medical devices across a tissue barrier, and charging and power transfer systems for electric vehicles (EVs). Wireless systems that use inductive coupling are referred to as Inductive power transfer (IPT) systems. These are commonly used for EVs have been proposed and developed rapidly to enable reliable and convenient wireless charging.

IPT systems operate using magnetic couplers, one being a primary or transmitter magnetic structure (often referred to as primary coupler or pad) to make a magnetic field available to couple with a secondary or receiver magnetic structure (often referred to as secondary coupler or pad). The secondary coupler is typically part of, or installed on, a device that requires power, for example an EV or mobile telephone. Couplers generally have at least one multi-turn coil which is controlled to generate or receive the magnetic field through which power is transferred. To guarantee robust, efficient, and cost-effective IPT operation, the system essentially requires couplers that have good performance, particularly good coil performance. Coil, or magnetic structure, design has been intensively studied and optimized for different IPT systems.

However, various challenges have occurred and remain unsettled for some wireless applications, especially for dynamic charging. In IPT systems, wireless charging is enabled through power transfer across an air gap through mutual inductance, M, between the inductively coupled coils (windings) of the primary and secondary pads. Existing IPT magnetic structures often have complex coil configurations which can be expensive to manufacture. They also tend to have large inductances which can cause difficulties when operating at high frequencies and require compensation circuits which also add to cost. Finally, existing magnetic structures are often very sensitive to misalignment.

### SUMMARY OF INVENTION

In a first aspect the present invention may be said to broadly consist in a wireless power transfer apparatus, the apparatus comprising a first coupling member configured to be magnetically coupled to a second coupling member, the first coupling member comprising:
at least one conducting member configured to provide a magnetic field for the wireless power transfer;
a first end; and
a second end opposite the first end, wherein:
the first coupling member is provided in a layer configuration; and
the conducting member extends from the first end to the second end and is configured to distribute current alternately across the layer between the first and second ends.

In an embodiment of the present invention, the magnetic flux generated by each first coupling member is at least substantially provided on one side of the first coupling member.

In another embodiment of the present invention, the first coupling members is unipolar.

In a further embodiment of the present invention, the first coupling member is non-polarized.

In yet another embodiment of the present invention, the pole is proximate to or at a side of the first coupling member.

In yet another embodiment a distribution means or a termination means is provided at each end of the at least one conducting member to distribute current across the member in a direction orthogonal to an axis extending between the two sides.

In yet another embodiment of the present invention, the first coupling member is a transmitter and the second coupling member is a receiver.

In yet another embodiment of the present invention, the vehicle comprises the second coupling member.

In yet another embodiment of the present invention, the first coupling member is positioned in an array arrangement.

In yet another embodiment of the present invention, the apparatus is configured to receive an excitation current in parallel or orthogonal to the moving direction of the vehicle.

In yet another embodiment of the present invention, the excitation current is configured to be applied to a side of the first coupling member.

In yet another embodiment of the present invention, the first coupling member comprises a magnetically permeable member.

In yet another of the present invention, the magnetically permeable member comprises a flat plate or C-shaped configuration.

In yet another embodiment of the present invention, the conducting member comprises a flat foil.

In yet another embodiment of the present invention, the flat foil is made up of copper.

In yet another embodiment of the present invention, the conducting member comprises multiple turns of paralleled litz wire.

In yet another embodiment of the present invention, the second coupling member is positioned vertically and perpendicularly to the first coupling member.

In yet another embodiment of the present invention, the second coupling member comprises a receiving coil.

In yet another embodiment of the present invention, the second coupling member comprises an air core.

In a second aspect the present invention may be said to broadly consist in a wireless power transfer apparatus, the apparatus comprising a first end and a second end opposite the first end, one or more first coupling members configured to be magnetically coupled to one or more second coupling members, each first coupling member comprising:
at least one conducting member configured to provide a magnetic field for the wireless power transfer;
wherein:
each of the one or more first coupling members are provided in a layer configuration; and
the at least one conducting member is configured such that when a current component is flowing from the first end to the second end there is no current component flowing in the opposite direction.

In an embodiment of the present invention, the magnetic flux generated by each first coupling member is at least substantially provided on one side of the first coupling member.

In another embodiment of the present invention, the first coupling members is unipolar.

In a further embodiment of the present invention, the first coupling member is non-polarized.

In yet another embodiment of the present invention, the pole is proximate to or at a side of the first coupling member.

In yet another embodiment a distribution means or a termination means is provided at each end of the at least one conducting member to distribute current across the member in a direction orthogonal to an axis extending between the two sides.

In yet another embodiment of the present invention, the one or more first coupling members are transmitters and the one or more second coupling members are receivers.

In yet another embodiment of the present invention, the vehicle comprises the one or more second coupling members.

In yet another embodiment of the present invention, the one or more first coupling members are positioned in an array arrangement.

In yet another embodiment of the present invention, the apparatus is configured to receive an excitation current in parallel or orthogonal to the moving direction of the vehicle.

In yet another embodiment of the present invention, the excitation current is configured to be applied to a side of the one or more first coupling members.

In yet another embodiment of the present invention, the one or more first coupling members comprise a magnetically permeable member.

In yet another of the present invention, the magnetically permeable member comprises a flat plate or C-shaped configuration.

In yet another embodiment of the present invention, the conducting member comprises a flat foil.

In yet another embodiment of the present invention, the flat foil is made up of copper.

In yet another embodiment of the present invention, the conducting member comprises multiple turns of paralleled litz wire.

In yet another embodiment of the present invention, the one or more second coupling members are positioned vertically and perpendicularly to the one or more first coupling members.

In yet another embodiment of the present invention, the one or more second coupling members comprise a receiving coil.

In yet another embodiment of the present invention, the one or more second coupling members comprise an air core.

In a third aspect the present invention may be said to broadly consist in a wireless power transfer apparatus, the apparatus comprising one or more first coupling members configured to be magnetically coupled to one or more second coupling members, each first coupling member comprising:
at least one conducting member configured to provide a magnetic field for the wireless power transfer;
a first end; and
a second end opposite the first end, wherein:
each of the one or more first coupling members are provided in a layer configuration; and
the at least one conducting member is a sheet of electrically conductive material extending from the first side and terminating at the second side.

In an embodiment of the present invention, the magnetic flux generated by each first coupling member is at least substantially provided on one side of the first coupling member.

In another embodiment of the present invention, the first coupling members is unipolar.

In a further embodiment of the present invention, the first coupling member is non-polarized.

In yet another embodiment of the present invention, the pole is proximate to or at a side of the first coupling member.

In yet another embodiment a distribution means or a termination means is provided at each end of the at least one conducting member to distribute current across the member in a direction orthogonal to an axis extending between the two sides.

In yet another embodiment of the present invention, the one or more first coupling members are transmitters and the one or more second coupling members are receivers.

In yet another embodiment of the present invention, the vehicle comprises the one or more second coupling members.

In yet another embodiment of the present invention, the one or more first coupling members are positioned in an array arrangement.

In yet another embodiment of the present invention, the apparatus is configured to receive an excitation current in parallel or orthogonal to the moving direction of the vehicle.

In yet another embodiment of the present invention, the excitation current is configured to be applied to a side of the one or more first coupling members.

In yet another embodiment of the present invention, the one or more first coupling members comprise a magnetically permeable member.

In yet another of the present invention, the magnetically permeable member comprises a flat plate or C-shaped configuration.

In yet another embodiment of the present invention, the conducting member comprises a flat foil.

In yet another embodiment of the present invention, the flat foil is made up of copper.

In yet another embodiment of the present invention, the one or more second coupling members are positioned vertically and perpendicularly to the one or more first coupling members.

In yet another embodiment of the present invention, the one or more second coupling members comprise a receiving coil.

In yet another embodiment of the present invention, the one or more second coupling members comprise an air core.

In a fourth aspect the present invention may be said to broadly consist in a wireless power transfer apparatus, the apparatus comprising one or more first coupling members configured to be magnetically coupled to one or more second coupling members, each first coupling member comprising:
a plurality of longitudinal conducting members configured to provide a magnetic field for the wireless power transfer;
a first end; and
a second end opposite the first end,
wherein:
each of the one or more first coupling members are provided in a layer or apad configuration; and
the plurality of longitudinal conducting members are spaced apart from each other in an orthogonal direction and extend from the first side and terminate at the second side.

In an embodiment of the present invention, the magnetic flux generated by each first coupling member is at least substantially provided on one side of the first coupling member.

In another embodiment of the present invention, the first coupling members is unipolar.

In a further embodiment of the present invention, the first coupling member is non-polarized.

In yet another embodiment of the present invention, the pole is proximate to or at a side of the first coupling member.

In yet another embodiment a distribution means or a termination means is provided at each end of the at least one conducting member to distribute current across the member in a direction orthogonal to an axis extending between the two sides.

In yet another embodiment of the present invention, the one or more first coupling members are transmitters and the one or more second coupling members are receivers.

In yet another embodiment of the present invention, the vehicle comprises the one or more second coupling members.

In yet another embodiment of the present invention, the one or more first coupling members are positioned in an array arrangement.

In yet another embodiment of the present invention, the apparatus is configured to receive an excitation current in parallel or orthogonal to the moving direction of the vehicle.

In yet another embodiment of the present invention, the excitation current is configured to be applied to a side of the one or more first coupling members.

In yet another embodiment of the present invention, the one or more first coupling members comprise a magnetically permeable member.

In yet another of the present invention, the magnetically permeable member comprises a flat plate or C-shaped configuration.

In yet another embodiment of the present invention, the conducting member comprises multiple turns of paralleled litz wire.

In yet another embodiment of the present invention, the one or more second coupling members are positioned vertically and perpendicularly to the one or more first coupling members.

In yet another embodiment of the present invention, the one or more second coupling members comprise a receiving coil.

In yet another embodiment of the present invention, the one or more second coupling members comprise an air core.

In a fifth aspect the present invention may be said to broadly consist in a wireless power transfer apparatus, the apparatus comprising one or more first coupling members, each first coupling member comprising a conducting member configured to provide a magnetic field for the wireless power transfer, wherein:
the one or more first coupling members are configured to be magnetically coupled to one or more second coupling members; and
the conducting member is only used to provide the forward path for an excitation current.

In an embodiment of the present invention, the magnetic flux generated by each first coupling member is at least substantially provided on one side of the first coupling member.

In another embodiment of the present invention, the one or more first coupling members are unipolar.

In a further embodiment of the present invention, the one or more first coupling members are non-polarized.

In yet another embodiment of the present invention, the pole is proximate to or at a side of the first coupling member.

In an embodiment a distribution means or a termination means is provided at each end of the conducting member to distribute current across the member in a direction orthogonal to an axis extending between the two sides.

In yet another embodiment of the present invention, the one or more first coupling members are transmitters and the one or more second coupling members are receivers.

In yet another embodiment of the present invention, the vehicle comprises the one or more second coupling members.

In yet another embodiment of the present invention, the one or more first coupling members are positioned in an array arrangement.

In yet another embodiment of the present invention, the apparatus is configured to receive the excitation current in parallel or orthogonal to the moving direction of the vehicle.

In yet another embodiment of the present invention, the excitation current is configured to be applied to a side of the one or more first coupling members.

In yet another embodiment of the present invention, the one or more first coupling members each comprise a magnetically permeable member.

In yet another of the present invention, the magnetically permeable member comprises a flat plate or C-shaped configuration.

In yet another embodiment of the present invention, the conducting member comprises a flat foil.

In yet another embodiment of the present invention, the flat foil is made up of copper.

In yet another embodiment of the present invention, the conducting member comprises multiple turns of paralleled litz wire.

In yet another embodiment of the present invention, the one or more second coupling members are positioned vertically and perpendicularly to the one or more first coupling members.

In yet another embodiment of the present invention, the one or more second coupling members comprise a receiving coil.

In yet another embodiment of the present invention, the one or more second coupling members comprises an air core.

In a sixth aspect the present invention may be said to broadly consist in a wireless power transfer system, the system comprising:
one or more transmitting pads, each of the transmitting pads comprising a conducting member;
and
at least one receiving member,
wherein:
the one or more transmitting pads are configured to be magnetically coupled the at least one receiving member; and
the conducting member is only used to provide the forward path for an excitation current.

In an embodiment of the present invention, the one or more transmitting pads are unipolar.

In another embodiment of the present invention, the pole is on a side of the transmitting pads.

In a further embodiment of the present invention, the one or more transmitting pads are positioned in an array arrangement.

In yet another embodiment of the present invention, the one or more transmitting pads are configured to receive the excitation current in parallel or orthogonal to the moving direction of the vehicle.

In yet another embodiment of the present invention, the excitation current is configured to be applied to a side of the one or more transmitting members.

In yet another embodiment of the present invention, the one or more transmitting pads each comprise a magnetically permeable member.

In yet another of the present invention, the magnetically permeable member comprises a flat plate or C-shaped configuration.

In yet another embodiment of the present invention, the conducting member comprises a flat foil.

In yet another embodiment of the present invention, the flat foil is made up of copper.

In yet another embodiment of the present invention, the conducting member comprises multiple turns of paralleled litz wire.

In yet another embodiment of the present invention, the one or more receiving members are positioned vertically and perpendicularly to the one or more transmitting pads.

In yet another embodiment of the present invention, the at least one receiving member comprises a receiving coil.

In yet another embodiment of the present invention, the at least one receiving member comprises an air core.

In a seventh aspect the present invention may be said to broadly consist in a wireless power transfer system, the system comprising:
at least one receiving member of the vehicle; and
one or more transmitting pads configured to be magnetically coupled the at least one receiving member,
wherein:
the magnetic flux generated by each transmitting pad is at least substantially provided on one side of the transmitting pad; and
the at least one receiving member is positioned at least substantially perpendicularly to the one or more transmitting pads.

In an eighth aspect the present invention may be said to broadly consist in a wireless power transfer system, the system comprising:
at least one receiving member of the vehicle; and
one or more transmitting pads configured to be magnetically coupled the at least one receiving member,
wherein:
the magnetic flux generated by each transmitting pad is at least substantially provided on one side of the transmitting pad; and
the at least one receiving member comprises an air core.

In an eight aspect, a wireless power transfer coupling apparatus is provided, comprising:
at least one conductive member configured as a layer of the first coupling member to provide a magnetic field for wireless power transfer, the conductive member having;
a first end; and
a second end opposite the first end, wherein:
the conductive member extends from the first end to the second end along a lengthwise axis of the coupling apparatus and is configured to distribute current across the layer between the first and second ends.

In a ninth aspect a method of wireless power transfer between an uncompensated primary coupler and a capacitor compensated secondary is provided comprising fully compensating the reactance of the primary coupler by a reflected impedance.

The disclosed subject matter also provides method or system which may broadly be said to consist in the parts, elements and features referred to or indicated in this specification, individually or collectively, in any or all combinations of two or more of those parts, elements or features. Where specific integers are mentioned in this specification which have known equivalents in the art to which the invention relates, such known equivalents are deemed to be incorporated in the specification.

Further aspects of the invention, which should be considered in all its novel aspects, will become apparent from the following description.

### DRAWING DESCRIPTION

A number of embodiments of the invention will now be described by way of example with reference to the drawings which are included in the description below.

FIG. 1 shows a diagrammatic isometric view of a first configuration of a wireless power transfer system (“Design 1”);

FIG. 2 shows a diagrammatic side elevation of FIG. 1;

FIG. 3 shows a diagrammatic isometric view of a second configuration of a wireless power transfer system (“Design 2”);

FIG. 4 shows a diagrammatic side elevation of FIG. 3;

FIG. 5 shows a diagrammatic isometric view of a third configuration of a wireless power transfer system (“Design 3”);

FIG. 6 shows a diagrammatic side elevation of FIG. 5;

FIG. 7 shows a diagrammatic isometric view of the field forming conductor of FIGS. 5 and 6;

FIGS. 8 to 14 are diagrammatic isometric views of a primary structure according to any of Designs 1 to 3 in conjunction with different secondary or receiver structures;

FIG. 15 shows the magnetic flux density [T] distribution of Design 1;

FIG. 16 shows the magnetic flux density [T] distribution of Design 2;

FIG. 17 shows the magnetic flux density [T] distribution of Design 3;

FIG. 18 (a) shows the loss density [W/m3] distribution in the foil conductor of Design 1 with flat ferrite;

FIG. 18 (b) shows the loss density [W/m3] distribution in the foil conductor of Design 2 with U-shaped ferrite;

FIG. 19 (a) shows a diagram of the flux lines (T) for Design 1;

FIG. 19 (b) shows a diagram of the approximate flux path for Design 1;

FIG. 20 shows a diagram of the flux tube illustrating the mutual coupling for the couplers of Design 1;

FIG. 21 (a) shows a diagram of the flux lines (T) for Design 2;

FIG. 21 (b) shows a diagram of the approximate flux path for Design 2;

FIG. 22 shows a diagram of the flux tube illustrating the mutual coupling for the couplers of Design 2;

FIG. 23 (a) shows a diagram of the flux lines (T) for Design 3;

FIG. 23 (b) shows a diagram of the approximate flux path for Design 3;

FIG. 24 shows a diagram of the flux tube illustrating the mutual coupling for the couplers of Design 3;

FIG. 25 (a) is a diagram of a first arrangement of transmitter coils for a dynamic IPT system;

FIG. 25 (b) is a diagram of a second arrangement of transmitter coils for a dynamic IPT system;

FIG. 26 shows the flux linkage between TX coils and RX coil against displacement for the arrangement of FIG. 25 (b);

FIG. 27 is an equivalent circuit diagram for Design 1;

FIG. 28 is a vector diagram of currents and voltages relating to the circuit of FIG. 27;

FIG. 29 shows the numerical results for the powers and currents of simulation 1 of Table 6;

FIG. 30 shows the numerical results for the powers and currents of simulation 4 of Table 6;

FIG. 31 (a) shows the variation of the primary inductance (H) and mutual inductance (H) with different heights (m) of the secondary above the primary for Design 1 (lower plot line) and Design 3 (upper plot line);

FIG. 31 (b) shows the variation of the mutual inductance (H) with different heights (m) of the secondary above the primary for Design 1 (lower plot line) and Design 3 (upper plot line);

FIG. 32 (a) shows the variation of the current amplitude |IP| (A) or |IS| (A) and the reactive power QS with different heights above the primary for Design 1 (upper plot line) and Design 3 (lower plot line);

FIG. 32 (b) shows the variation of the current amplitude |IP| (A) or |IS| (A) and the reactive power QS with different heights above the primary for Design 1 (lower plot line) and Design 3 (upper plot line);

FIG. 33 is a diagram showing a secondary located in a vertical plane (perpendicular to a plane of the transmitter) disposed at angle theta relative to a central longitudinal or lengthwise axis of the field forming conductor of the transmitter.

FIG. 34 (a) shows the variation of the primary self-inductance (H) of Design 1 and Design 3 (upper plot) with different angles theta (refer FIG. 33);

FIG. 34 (b) shows the variation of the mutual inductance (H) of Design 1 (lower plot) and Design 3 (upper plot) with different angles theta (refer FIG. 33);

FIG. 35 (a) shows the variation of the primary self-inductance (H) of Design 1 and Design 3 (upper plot) with different angles theta (refer FIG. 33);

FIG. 35 (b) shows the variation of the mutual inductance (H) of Design 1 (lower plot) and Design 3 (upper plot) with different angles theta (refer FIG. 33);

FIG. 36 (a) shows the variation of the mutual inductance (H) of Design 3 with different conductor (“coil”) widths (cm) and heights to the secondary (m);

FIG. 36 (b) shows the variation of the primary self-inductance (H) of Design 3 with different conductor (“coil”) widths (cm) and heights to the secondary (m);

FIG. 36 (c) shows the variation of the absolute value of primary or secondary current (Arms) of Design 3 with different conductor (“coil”) widths (cm) and heights to the secondary (m);

FIG. 36 (d) shows the variation of Qs (Var) of Design 3 with different conductor (“coil”) widths (cm) and heights to the secondary (m);

FIG. 37 shows a circuit diagram for switches of an H bridge converter used for example to drive or energise a field forming conductor, together with the waveforms for the current duty cycle D;

FIG. 38 shows the waveforms for the switching process for FIG. 37;

FIG. 39 shows an example of an alternative converter switch topology;

FIG. 40 shows a circuit diagram for an IPT system including a primary and secondary structure according to any of the examples discussed above, and showing the compensation topology for the second side;

FIG. 41 shows a phasor diagram for the system of FIG. 40 when Xs is fully compensated;

FIG. 42 shows a phasor diagram for the system of FIG. 40 when Xp is fully compensated;

FIG. 43 shows a phasor diagram for series-series compensation for the system of FIG. 40;

FIG. 44 shows plots illustrating current, voltage, apparent power, and efficiency for case 1;

FIG. 45 is a diagrammatic cross section of a system according to Design 3 illustrating measured @; in the receiver RX;

FIG. 46 (a)-46 (c) show plots for CV, power loss (W) and normalized cost;

FIG. 47 shows variation between CV, cost and Ploss;

FIG. 48 shows a ccomparisons of calculated and simulated receiver flux with horizontal displacements.

### DETAILED DESCRIPTION

The present invention is a wireless power transfer (WPT) apparatus including an inductive power transfer (IPT) apparatus useful for the wireless charging or powering of a large range of devices, including for example consumer devices, such as mobile communication devices for example, and electric vehicles, ranging for example from drones to cars or trucks.

The IPT apparatus and control disclosed herein enable stable, efficient, economical, and safe dynamic charging for mobile devices including electric vehicles (EVs). Although vehicles are referred to herein by way of example it will be appreciated by those skilled in the art that this disclosure is applicable to many other WPT/IPT applications.

The transmitter of the inductive power transfer apparatus of the present invention is unlike existing constructions in that it is not formed as a coil, so there are no turns in the conductor that produces the field for power transfer. It may instead be considered as a conductor configured as a layer i.e. a conductive region that has a longitudinal dimension and a transverse dimension, both of which are significantly greater than its depth or thickness dimension.

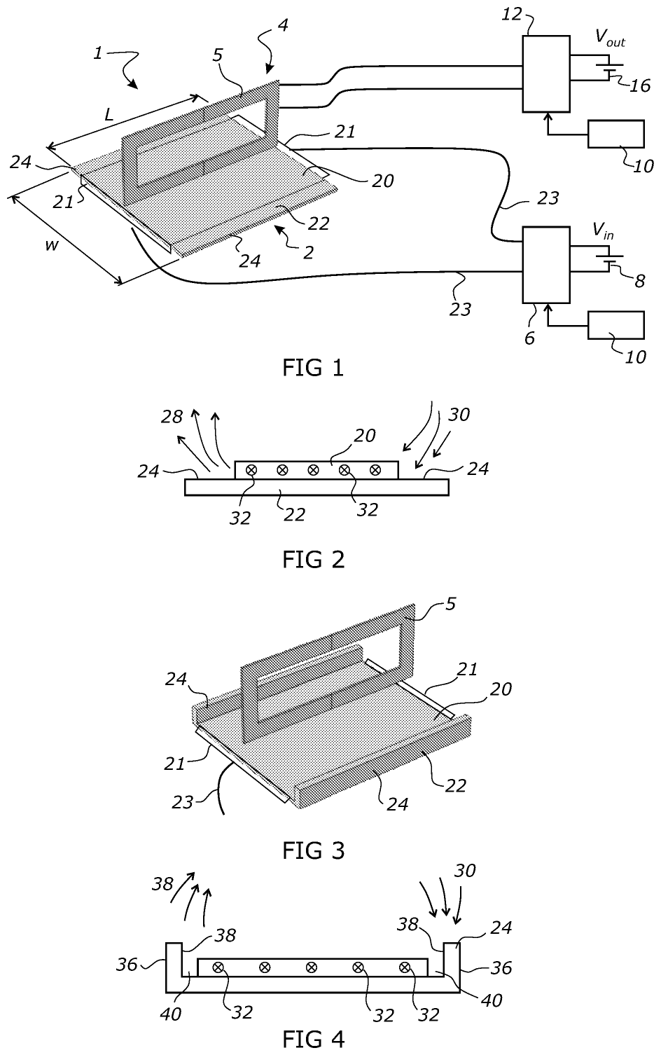

Some examples of primary magnetic coupling structures which have a conductor layer configuration are shown in FIGS. 1 to 7. Referring to FIGS. 1 to 7, an IPT system is shown generally referenced 1 having a primary or transmitter apparatus comprising a magnetic structure 2 in the form of a pad and a secondary or receiver apparatus 4 which is disposed adjacent to, but spaced from, the pad 2.

As shown in FIG. 1, the primary structure is electrically connected to a converter 6 supplied by a voltage source 8. A primary controller 10 is configured to operate the converter to deliver an alternating current to drive or energize the structure 2.

Similarly, still referring to FIG. 1, secondary coupler structure 4 is electrically connected to a converter or rectifier 12 that may be controlled, if required, by controller 14 to provide an output power 16 which may be used to supply a load, for example to charge a battery.

The power supplies 8, 16, controllers 10, 14 and converters/rectifiers 6, 12 such as those shown in FIG. 1 are omitted for clarity in some other figures such as FIGS. 2-7, but it will be understood that these may be used as required with the apparatus described or illustrated herein to realise wireless power transfer components or systems.

In FIGS. 1 to 4, the primary coupler 2 has a field forming conductor 20 which is formed as a thin layer of conductive sheet material which in this example comprises a foil, such a copper or aluminium foil that is laid over a layer of magnetically permeable material 20 such as ferrite which is provided as a ferrite plate. The conductor has a length L and a width W which is transverse to the length. Both L and W are much greater than the thickness of the conductor (i.e. the dimension of the conductor that is perpendicular to the length and width dimensions).

Either end of conductor 20 has a termination 21, each of which enable a secure electrical connection to be made between the conductor 20 and the cables 23 that conduct current between the field forming conductor 20 and the converter 6. The terminations 21 allow the current to be distributed across the width of the conductor 20.

The permeable layer 22 has regions 24 that are not covered by the conductor 20. Regions 24 can act as pole regions for the field produced in use by the conductor 20 to enter and exit the permeable layer 22 and thus guide a flux path that forms a loop or arch over the conductor 20 and into a power transfer region 26 on a side of the conductor 20 that is opposite to the side on which the permeable layer 22 is provided. The field shape is indicated by arrows 28 and 30 in FIG. 2 when current is flowing through the conductor 20 into the page as indicated by arrows 32. The size of regions 24 and the width of conductor 20, or their relative dimensions of the conductor 20 and the pole regions 24 can be adjusted to provide a required field shape in use. For example, making the conductor 20 wider may provide a flatter or lower field extending across the width of the coupler. This may be advantageous for allowing a wider or broader power transfer region 26 for coupling with a secondary, meaning that there is a reduced requirement for precise alignment for effective power transfer to occur. In some examples regions 24 may not be provided i.e. the permeable material 22 may end at, or within, the side edges of the conductor 20.

The foil conductor 20 in the example shown in FIGS. 3 and 4 is the same as that described above with reference to FIGS. 1 and 2, but the exposed regions 24 of the permeable layer in FIGS. 3 and 4 are raised to present one or more walls 36 and/or 38 which provide additional or alternative exposed surfaces by which the field may enter and exit the permeable material. The permeable material 22 in the FIG. 3 and FIG. 4 example may take to form of a “U” or “C” shape. As shown in FIG. 4, there may in some examples be gaps 40 between the inner walls 38 of the permeable material 22 and the sides of the conductor 20. Gaps 40 may not be present in some examples. If gaps 40 are present, their dimensions may be adjusted to provide a required field shape.

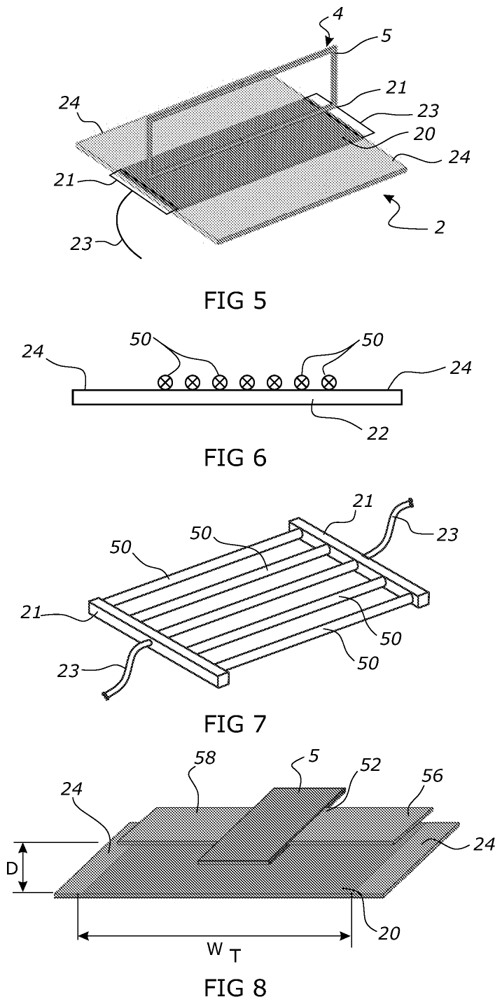

Turning now to FIGS. 5 to 8, another example is shown in which the conductor 20 comprises a plurality of individual lengths of conducting wire or cable 50, such as litz wire. The individual wires 50 are not shown in FIG. 5 for clarity, however an example of the conductor 20 is illustrated in FIG. 7 without permeable layer 22. The gaps between wires 50 are configured to provide a required field or flux pattern. In some embodiments or examples the wires 50 are spaced many wire diameters apart, and in others around one wire diameter apart, or less than one wire diameter apart from each other. As with the examples described above, the terminals 21 conduct and distribute current from wires 23 to the wires 50.

The secondary coupler 4 in the examples discussed and shown above comprises a coil 5 which can be wound as a multi-turn coil of a suitable conductor such as litz wire. The coil 5 may in some examples be flat, i.e. wound as a spiral. As shown in FIGS. 1, 3 and 5 the coil 5 is vertically oriented, i.e. it is arranged or provided in a vertical plane that extend along the lengthwise axis of the field forming conductor 20.

The field forming conductors 20 shown in the examples above, together with the permeable plate 22 provide magnetic fields in a coupling region above the primary structure and very little or no field on the underside of the structure. Therefore, the conductors 20 can produce a single-sided flux pattern without having the returning wires that are required when forming a coil. There is no coil arrangement that creates a return path as in the prior art in which components of current flow in opposite directions across the structure at the same time. Accordingly, the flat conductor region can generate wide and flat magnetic flux above its upper surface.

The air-cored vertical receiving coil 5 can capture most of the produced flux by the primary, which significantly benefits dynamic wireless charging for applications such as moving EVs. The ferrite plates 22 is coupled with the transmitting coil to strengthen the coupling and reduce the flux leakage. In some examples or embodiments a shield (such as an aluminium pate) may be provided beneath the lower surface of the ferrite 22 to further assist with producing a required magnetic flux pattern, or to assist with reducing leakage fields around the sides and base of the coupler.

For some applications use of copper foil for conductor 20 will be preferable as it is much more cost-efficient than Litz wire. In EV applications for example a foil transmitting coil 20 is mounted in the roadway while the receiver is mounted at the bottom of the car chassis.

However, in other applications the transmitting coil may be mounted in a charging device, and the receiving coil in a consumer electronic device, such as a mobile phone. For example, the receiver coil 5 may be connected by a hinge or extension that allows the coil to be moved out from the surface of the phone such that it is vertically oriented in relation to the transmitter coil.

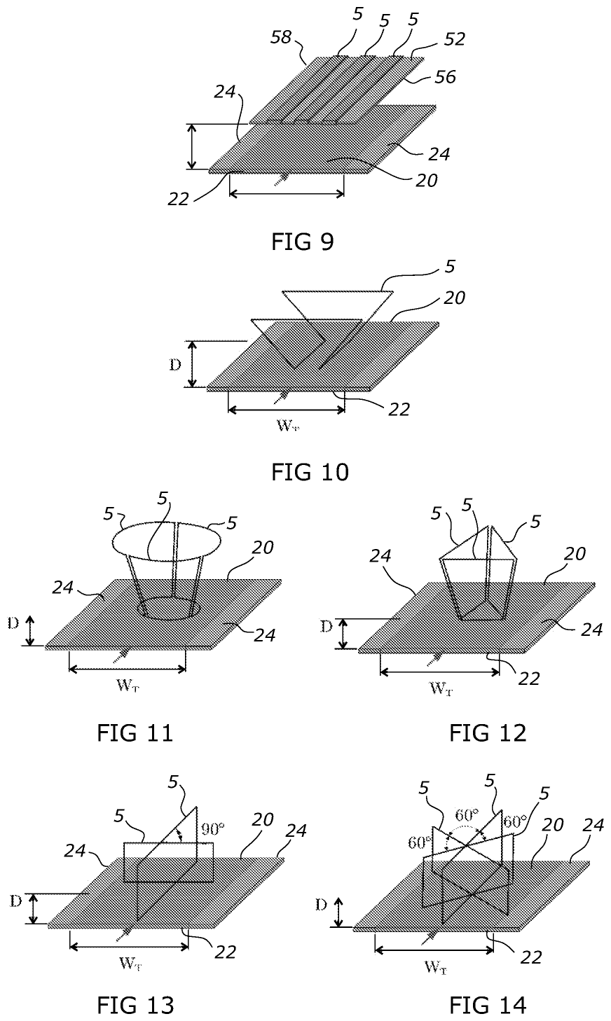

FIGS. 8 and 9 show other examples or embodiments for the secondary coupler 4 in which the coil 5 has a different form, and in which permeable material 52 such as a ferrite may be used in conjunction with coil 5 to enhance the field coupled from the primary.

Thus, in FIG. 8, the coil 5 comprises a solenoid, and which has been wound in a flat form, provided a distance D above the primary structure. As shown, the solenoid winding 5 may be provided in a plane that is generally parallel to the flat field forming conductor 20. In the example shown the coil 5 is magnetically associated with permeable material 52 and may be wound around the permeable material. In some examples the permeable material may be flat and/or oriented parallel to the permeable material 22 or conductor 20 of the primary coupler. In some examples the permeable material 52 may not extend beyond the edges of coil 5, and in other examples such as that of FIG. 8, the permeable material 52 has exposed regions 56 and 58 that may provide pole areas for entry and exit of magnetic flux and couple with the pole areas 24 of the primary coupler.

In FIG. 9, the secondary also has permeable material as described above, but the coil 5 is provided as a plurality of coils that are spread, spaced, or distributed across the width of the receiver structure. In another example, the coils 5 shown in FIG. 9 are modular units which may be used with or without permeable material and added to, or removed from, the secondary as required for the particular application.

In FIGS. 10 to 14, coils 5 that do not necessarily include permeable material i.e. air-cored coils which are shown in several exemplary configurations are shown. These coils may be multi-turn or possibly single turn depending on the required application. The various configurations may include more than one coil, as shown in FIGS. 11-14. The coils shown in FIGS. 10 to 14 allow spatial coil arrangements that can be adopted to increase the misalignment tolerance while still possessing the advantage of vertical components of orientation that are efficient for flux capture. As can be seen most clearly in FIGS. 13 and 14, multiple coils can be arranged or configured spatially to provide greater tolerance to possible angular or translational misalignment between the secondary coil(s) and the primary conductor 20.

Again, for each of the examples or embodiments in FIGS. 10 to 14 the transmitting conductor 20 does not have or require a return winding on the backside of the ferrite plate 22, therefore producing no back magnetomotive force (MMF).

The flux patterns and performance of the coil pairs detailed above will be demonstrated below.

The simulated coil pairs for comparison includes five types: the transmitter with a flat ferrite-vertical receiver as shown in FIGS. 1 and 2 (hereinafter “Design 1”); foil transmitter with U-shaped ferrite-vertical receiver as shown in FIGS. 3 and 4 (“Design 2”); flat Litz-paralleled transmitter with ferrite-vertical receiver as shown in FIGS. 5 to 7 (“Design 3”). Their simulation models are shown below in FIGS. 3 to 5. The excitation direction is also shown in these figures with a red arrow. The geometric parameters of these designs are given in Table 2.

To fairly compare their performance, the transmitting coils have the same MMF of 24 At. Except for Design 2 with narrower C-shaped ferrite, the size of the other four transmitters is identical. The transmitting coil may be covered by a plastic cover with a thickness of 5 mm (but it is not at all necessary to have a cover). In the example application of EV car charging, the air gap between the ground and the car chassis is set as 0.21 m. The size of the vertical receiver is restricted by the height of the car chassis and its width is set to be 0.15 m.

The skin depth of copper foil can be calculated using (1).

$$δ = \frac{1}{\sqrt{π f μ σ}} \qquad ( 1 )$$

Where μ is 4πE-7 H/m and σ is 5.8E7 S/m for copper. Therefore, the skin depth at 85 kHz (frequency used for EV wireless charging) is about 0.23 mm. The thickness of the copper foil was then chosen as 0.5 mm, and its width as 0.2 m to allow for an acceptable misalignment tolerance. The foil coil has only one layer. Therefore, the cross-section area of the foil winding is 0.1E-3 m², which means its mean current density is 2.4E-5 A/m² (0.24 A/mm²).

TABLE 2
Geometric parameters of different coils

| | Width | Length | Turn | Distance |
|---|---|---|---|---|
| Coil pair | (m) | (m) | number | (m) |
| Deign 1: Primary | 0.2 | 0.5 | 1 | 0.02 |
| Secondary | 0.15 | 0.5 | 2 | |
| Design 2: Primary | 0.2 | 0.5 | 1 | 0.02 |
| Secondary | 0.15 | 0.5 | 2 | |
| Design 3: Primary | 0.2 | 0.5 | 40 (Parallel) | 0.02 |
| Secondary | 0.15 | 0.5 | 2 | |

Litz wire with a diameter of 5 mm was selected to wind the Litz coils. The number of turns of the transmitting Litz coils is determined to be 40 to keep the width of foil coil and Litz coils the same. Therefore, the current in each turn is 0.6 A. Meanwhile, the turn number of the vertical receiver is chosen to be 2.

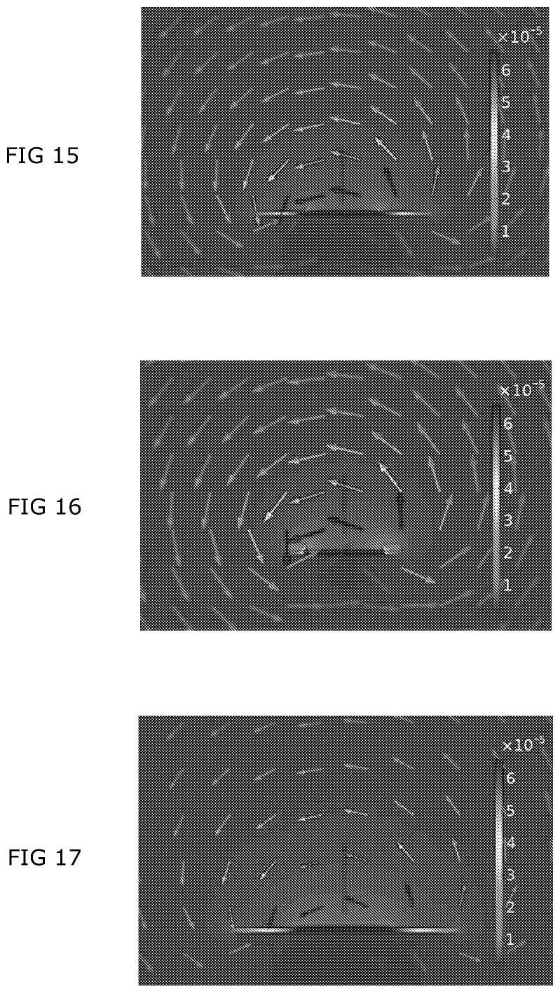

The magnetic flux distribution in a central cut plane i.e. a cross section taken through the centre of the transmitter and receiver structures, the cut plane of the cross section being transverse to the lengthwise direction (longitudinal axis) of the conductor 20, is shown in FIGS. 15 to 17. Electric parameters of the designs when the receiver is aligned are given in Table 3 below.

FIGS. 15 to 17 show the magnetic flux density B distribution in the central cut plane of these three designs. It can be seen in FIGS. 15 and 16 that the foil transmitting conductor can generate flat and stable horizontal flux patterns over the conductor surface. Therefore, the vertical receiving coil has a strong lateral misalignment tolerance. The flux patterns of Design 1 and Design 3 are quite similar. Moreover, the flux density of the foil coil with a U-shaped ferrite plate (Design 2) is slightly stronger than that with a flat ferrite plate (Design 1).

TABLE 3
Electric parameter comparison when aligned

| | V₂ | Phi₂ | I₁ | L₁ | M | L₂ |
|---|---|---|---|---|---|---|
| Coil pair | (V) | (Wb) | (A) | (μH) | (μH) | (μH) |
| Deign 1: Foil coil | 4.7 | 8.8E−6 | 24 | 0.56 | 0.37 | 3.50 |
| (ferrite plate) | | | | | | |
| Design 2: Foil coil | 4.74 | 8.88E−6 | 24 | 0.58 | 0.37 | 3.08 |
| (C-shaped | | | | | | |
| ferrite plate) | | | | | | |
| Design 3: Flat litz coil | 5.35 | 1.00E−5 | 24 | 0.58 | 0.42 | 3.21 |
| (ferrite plate) | | | | | | |

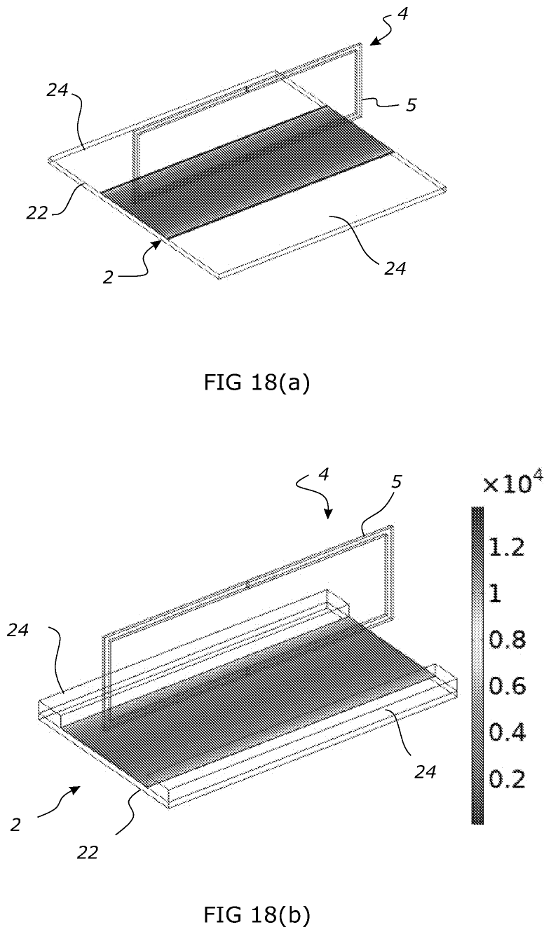

Table 4 gives the loss in foil conductor of Design 1 and Design 2. The foil transmitting conductor with U-shaped ferrite has a lower loss, as the ferrite around the two ends of the copper foil guides flux away from the copper, reducing the loss. FIG. 18 compares the loss density in the foil coil of these two designs. As can be seen, Design 2 with U-shaped ferrite has a smaller loss density.

TABLE 4
Foil conductor loss comparison

| Coupler Arrangement | Foil loss (W) |
|---|---|
| Deign 1: with flat ferrite plate | 0.102 |
| Design 2: with U-shaped ferrite plate | 0.06 |

In practical applications, the geometric parameters of the proposed designs can be quickly optimized through the reluctance-based modelling. Reluctance models established for Design 1, Design 2, and Design 3 are discussed below, along with their corresponding flux patterns and flux tubes of the mutual coupling. According to the flux patterns, the reluctance of the mutual coupling flux tube is calculated for each design based on the magnetic equivalent circuit (MEC) method.

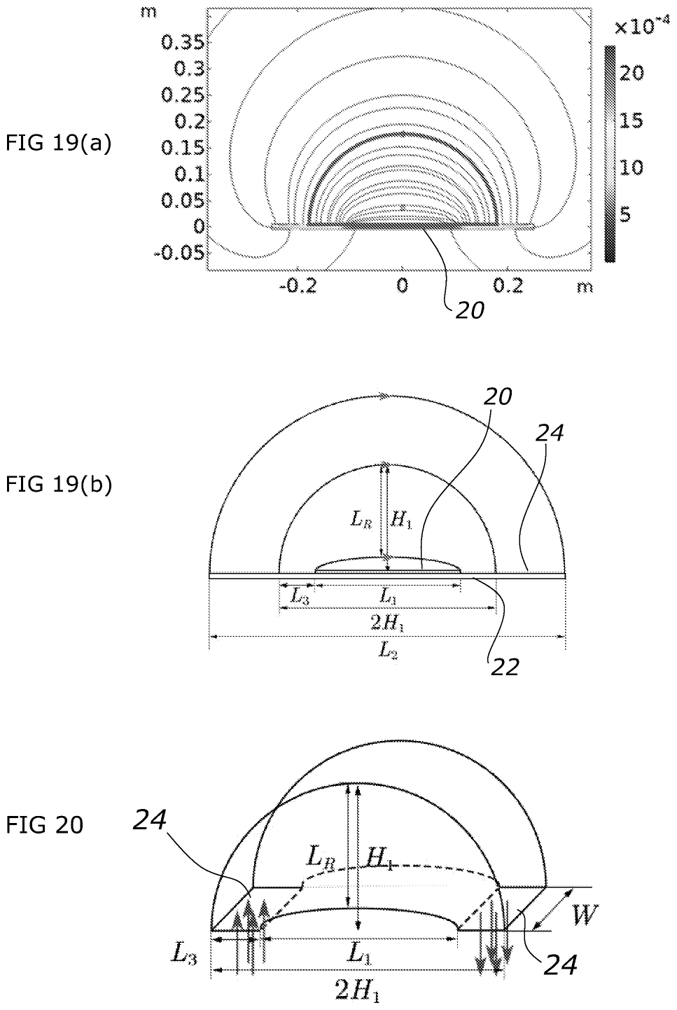

For the reluctance calculations, the magnetomotive force (MMF) drop in ferrite is neglected to simplify the analysis due to the relatively large permeability of ferrite materials. The flux distribution of Design 1 in the side view is shown in FIG. 19(a). FIG. 19(b) is the approximate flux path shape. FIG. 20 gives the geometry of the coupled flux tube of the vertical receiver. In FIG. 20, Hi is the height of the receiver, and L_{R} is the length of the receiver. L₁ is the length of the foil conductor's section, while W is the side width of the foil conductor, which is the same as the width of the vertical receiver.

The flux tube's inner and outer lengths are I₁ and I₂, respectively, as shown in (2) and (3). The equivalent magnetic reluctance of the mutual coupling part can then be obtained through effective flux length and area, as shown in (4) and (5). For the reluctance calculation of the other two designs, the process is the same.

$${l}_{1} = \frac{2 π ( {H}_{1} - {L}_{R} ) + 4 ( {L}_{1} / 2 - ( {H}_{1} - {L}_{R} ) )}{2} = {L}_{1} + ( π - 2 ) ( {H}_{1} - {L}_{R} ) \qquad ( 2 )$$

$${l}_{2} = π {H}_{1} \qquad ( 3 )$$

$${l}_{eff} = \frac{{l}_{1} + {l}_{2}}{2} \qquad ( 4 )$$

$${A}_{eff} = \frac{{L}_{3} W + {L}_{R} W}{2}$$

$$R = \frac{{l}_{eff}}{{μ}_{0} {A}_{eff}} \qquad ( 5 )$$

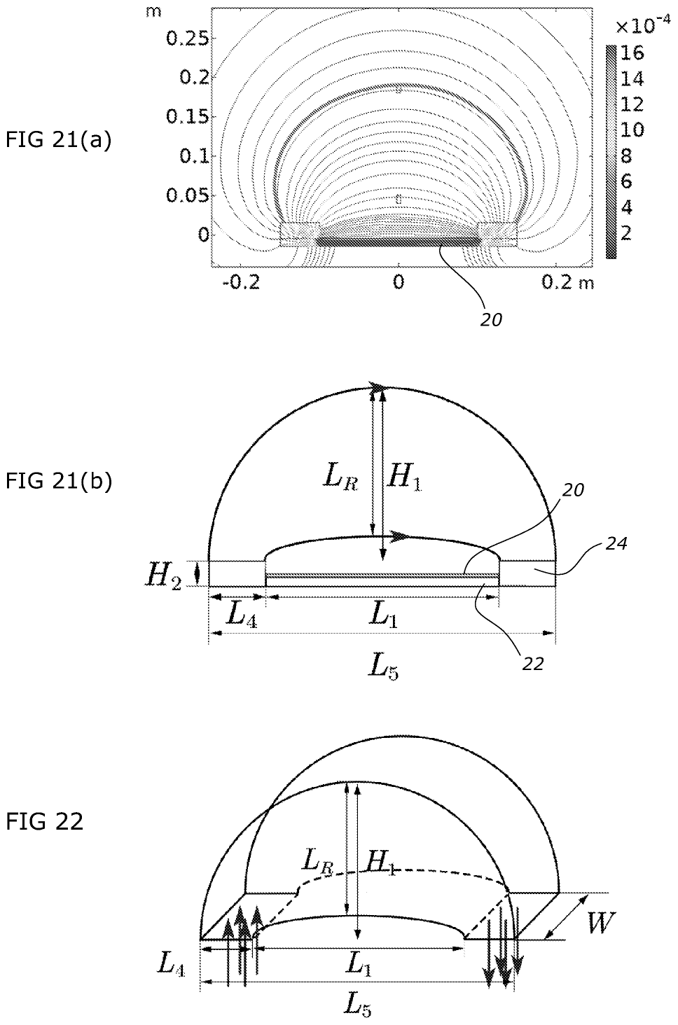

The flux distribution of Design 2 in the side view is shown in FIG. 21 (a). FIG. 21 (b) is the approximate flux path shape. FIG. 22 gives the geometry of the coupled flux tube of the vertical receiver. In FIG. 22, L₅ is the section length of the C-shaped ferrite.

The equivalent magnetic reluctance of the mutual coupling part can then be obtained through effective flux length and area of the tube, as shown from (6) to (9).

$${l}_{1} = \frac{2 π ( {H}_{1} - {L}_{R} ) + 4 ( {L}_{1} / 2 - ( {H}_{1} - {L}_{R} ) )}{2} = {L}_{1} + ( π - 2 ) ( {H}_{1} - {L}_{R} ) \qquad ( 6 )$$

$${l}_{2} = \frac{2 π ( {L}_{4} + \frac{{L}_{1}}{2} ) + 4 ( {H}_{1} - {L}_{4} - \frac{{L}_{1}}{2} )}{2} = ( π - 2 ) ( {L}_{4} + \frac{{L}_{1}}{2} ) + 2 {H}_{1} \qquad ( 7 )$$

$${l}_{eff} = \frac{{l}_{1} + {l}_{2}}{2} \qquad ( 8 )$$

$${A}_{eff} = \frac{{L}_{4} W + {L}_{R} W}{2}$$

$$R = \frac{{l}_{eff}}{{μ}_{0} {A}_{eff}} \qquad ( 9 )$$

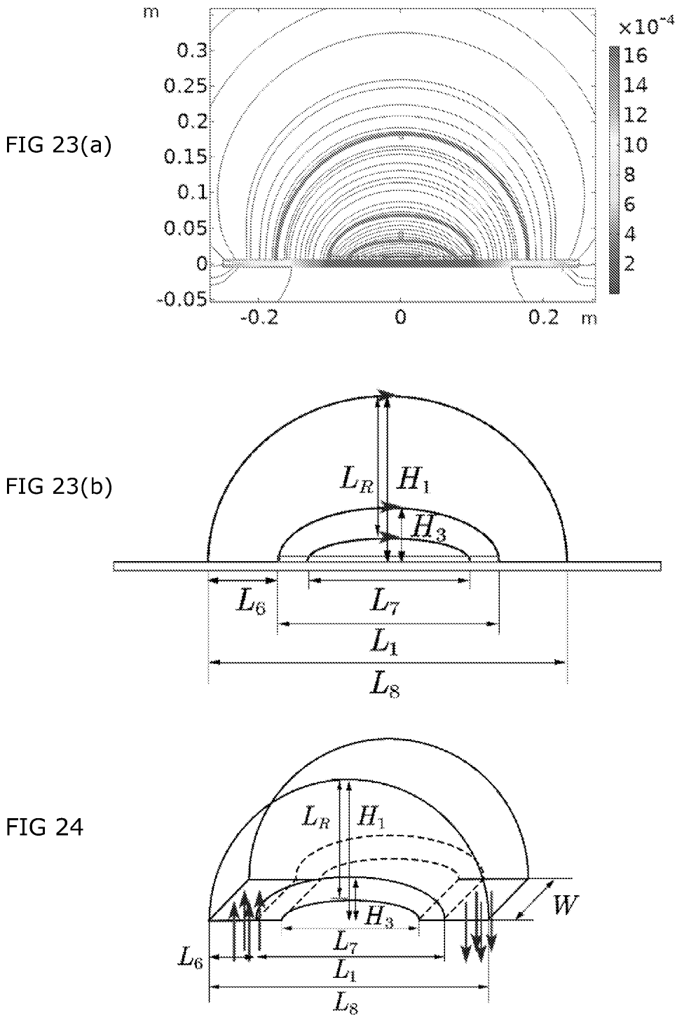

The flux distribution of Design 3 in the side view is shown in FIG. 23 (a). FIG. 23 (b) is the approximate flux path shape. FIG. 24 gives the geometry of the coupled flux tube of the vertical receiver. In FIG. 24, L₇ is the section length of the inner coupling flux boundary, and La is the section length of the outer coupling flux boundary.

As can be seen from the flux distribution, the mutual coupling flux includes two parts: the partially coupling part and the fully coupling part. Partially coupling refers to only part of the primary is coupled with the secondary. Fully coupling means all the primary is coupled with the secondary. In the equations below, the subscript P refers to the partially coupling flux, and F refers to the fully coupling flux. For the partially coupling part, the effective number of primary turns N₁′ can be obtained by considering the relationship between L₇ and Li, as shown in (10). N₁ is the total number of turns of the primary side. α is the ratio of the effective primary turns to the total turns.

$$α = \frac{{N}_{1}^{′}}{{N}_{1}} = \frac{\frac{{L}_{7} + {L}_{1}}{2}}{{L}_{1}} \qquad ( 10 )$$

The equivalent magnetic reluctance of these two mutual coupling parts can then be obtained through effective flux length and area of each tube, as shown from (11) to (18).

$${l}_{1 P} = \frac{2 π ( {H}_{1} - {L}_{R} ) + 4 ( {L}_{7} / 2 - ( {H}_{1} - {L}_{R} ) )}{2} = {L}_{7} + ( π - 2 ) ( {H}_{1} - {L}_{R} ) \qquad ( 11 )$$

$${l}_{2 P} = \frac{2 π {H}_{3} + 4 ( {L}_{1} / 2 - {H}_{3} )}{2} = {L}_{1} + ( π - 2 ) {H}_{3} \qquad ( 12 )$$

$${l}_{effP} = \frac{{l}_{1 P} + {l}_{2 P}}{2} \qquad ( 13 )$$

$${A}_{effP} = \frac{\frac{{L}_{1} - {L}_{7}}{2} W + ( {H}_{3} + {L}_{R} - {H}_{1} ) W}{2}$$

$${R}_{P} = \frac{{l}_{effP}}{{μ}_{0} {A}_{effP}} \qquad ( 14 )$$

$${l}_{1 F} = {l}_{2 P} = {L}_{1} + ( π - 2 ) {H}_{3} \qquad ( 15 )$$

$${l}_{2 F} = \frac{2 π {H}_{1} + 4 ( {L}_{8} / 2 - {H}_{1} )}{2} = {L}_{8} + ( π - 2 ) {H}_{1} \qquad ( 16 )$$

$${l}_{effF} = \frac{{l}_{1 F} + {l}_{2 F}}{2} \qquad ( 17 )$$

$${A}_{effF} = \frac{{L}_{6} W + ( {H}_{1} - {H}_{3} ) W}{2}$$

$${R}_{F} = \frac{{l}_{effF}}{{μ}_{0} {A}_{effF}} \qquad ( 18 )$$

The coupled flux linkage in the vertical receiver will now be calculated through the MEC method according to the calculated reluctance. The calculated flux linkage will be compared with the results obtained through the finite element method (FEM).

After obtaining the equivalent reluctance of each design, the coupling flux linkage can be obtained by (19).

$${Ψ}_{2} = {N}_{2} \frac{F}{R} \qquad ( 19 )$$

N₂ is the number of turns of the vertical receiver, which is 2. F is the MMF of the transmitter, which is 24 At. R is the calculated reluctance of the mutual coupling flux tube. For Design 3, its coupling flux linkage includes two parts: the fully coupling flux linkage and the partially coupling flux linkage. Therefore, its total coupling flux linkage can be obtained from (20).

$${Ψ}_{2} = {Ψ}_{F} + {Ψ}_{P} \qquad ( 20 )$$

$${Ψ}_{F} = {N}_{2} \frac{F}{{R}_{P}}$$

$${Ψ}_{P} = {N}_{2} \frac{α F}{{R}_{P}}$$

The obtained mutual flux linkage from MEC and FEM is given in Table 5 for the three designs. As can be seen, the reluctance models of Design 1 and Design 3 are reasonably accurate, while the error of the other one is lower than 10%, which is acceptable and can be further improved by refining the flux tubes.

TABLE 5
Comparison of coupling flux linkage (Wb)

| | FEM | MEC | Error |
|---|---|---|---|
| Deign 1: Foil conductor (ferrite | 8.8E−6 | 8.72E−6 | 0.9% |
| plate) | | | |
| Design 2: Foil conductor (C-shaped | 8.88E−6 | 8.04E−6 | 9.5% |
| ferrite plate) | | | |
| Design 3: Flat Litz conductor (ferrite | 1.00E−5 | 1.01E−5 | −1% |
| plate) | | | |

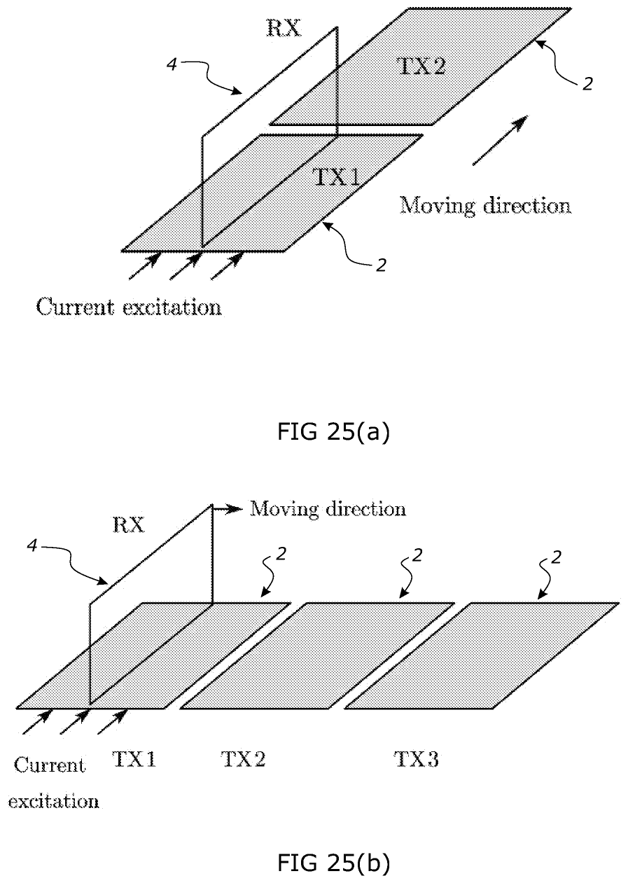

To implement the designs described above in a dynamic charging environment for EVs, there are at least two possible arrangements according to the direction of movement of the EV. These arrangements are shown in FIGS. 25(a) and (b). TX refers to the transmitting conductor, while RX represents the receiving coil.

In FIG. 25(a), the moving direction is the same as the excitation direction. In 25(b), the moving direction is orthogonal to the excitation direction, and the TX is placed along the lateral side. For the FIG. 25(a) arrangement, as the current can be seen as continuous in the moving direction when the TX distance is small, it can naturally produce smooth and stable coupling between TX and RX when the EV is moving. For the FIG. 25(b) arrangement, the coupling can be unstable when moving, as the flux is not always constant above one TX in this moving direction. However, the arrangement of FIG. 25(b) can provide superior results. It is helpful to consider achieving constant flux by designing the TX width and distance.

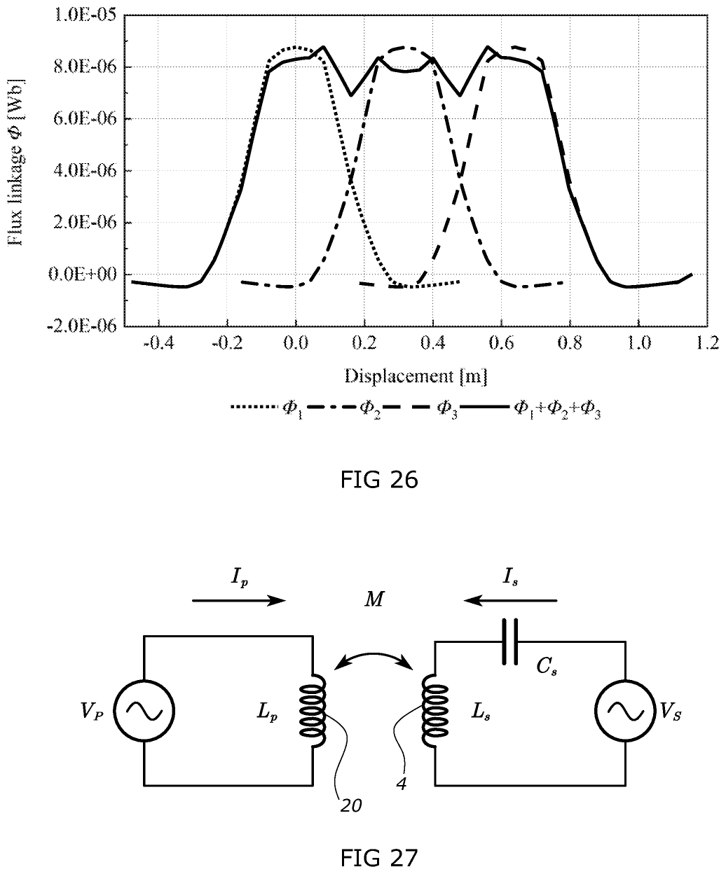

Design 1 with the geometric parameters in Table 2 is given as an example to study flux leveling. The calculated flux linkages between each TX coil and RX coil are shown in FIG. 26, where Φ1, Φ2, Φ3 are flux linkage produced by TX1, TX2, TX3, respectively. The gray line is the superimposed flux linkage produced by the three TX coils. It can be seen that by designing the TX coils size and distance between TX coils, a nearly leveled flux linkage profile can be achieved. This feature benefits the dynamic charging for the EVs since the induced voltage is proportional to the flux linkage, and less fluctuating flux leads to less fluctuation in induced voltage.

We now take Design 1 as an example for implementation in an EV dynamic charging application with a high-power level. Since the inductances of the transmitting conductors are relatively small, only the receiving side compensation is considered. The required excitation level and produced reactive power are calculated to achieve 30 kW power charging.

The equivalent circuit diagram is shown in FIG. 27, where Lₚ and Lₛ are inductances of TX and RX coils, Cₛ is the compensating capacitor resonating with Lₛ. Iₚ and Iₛ are the primary and secondary current. Vₚ and Vₛ are the primary input AC voltage and secondary output AC voltage.

The battery load with an active full-bridge converter can be equivalent to an AC voltage source Vₛ, as shown in FIG. 27, where the Vₛ can be modulated to achieve battery charging and the battery's voltage is V_{DC}, as expressed in (15):

$${V}_{S} = \frac{2 \sqrt{2}}{π} sin ( \frac{π}{2} D ) {V}_{DC} {e}^{j θ} , \qquad ( 15 )$$

Where D is the duty cycle, ranging from 0 to 1, 0 is the phase angle of Vₛ relative to primary AC voltage source VP, ranging from 0 to 180 degrees.

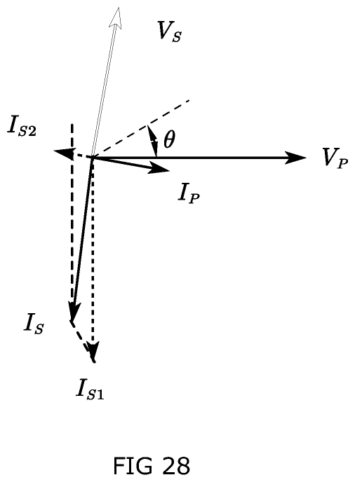

The primary currentIP and secondary currentIS are solved in (15). The vectors of currents and voltages are shown in FIG. 28. Note that Iₛ is the vector sum of the term1I_{S1} and term2I_{S2}. If | Vₚ|=| Vₛ|, |I_{S1}| is seven times larger than |I_{S2}| for the foil TX coil structure since the mutual inductance M is seven times larger than the TX coil's self-inductance Lₚ. Therefore, it is reasonable to use Isi to estimate the magnitude ofIS.

$$\{ \begin{matrix}{V}_{P} = j ω {L}_{P} + j ω {MI}_{S} \\ {V}_{S} = j ω {MI}_{P}\end{matrix} ⇒ \{ \begin{matrix}{I}_{P} = \frac{{V}_{S}}{j ω M} \\ {I}_{S} = \frac{{V}_{P}}{{\underbrace{j ω M}}_{{I}_{S 1}}} + \frac{{V}_{s}}{{\underbrace{- ( j ω M ) \frac{j ω M}{j ω {L}_{P}}}}_{{I}_{S 2}}}\end{matrix} \qquad ( 16 )$$

The power flows out of the voltage source Vₚ and Vₛ can be calculated by numerical methods through (17).

$${P}_{P} = Re \{ {V}_{P} {I}_{P}^{*} \} , \qquad ( 17 )$$

$${P}_{s} = Re \{ {V}_{S} {I}_{s}^{*} \}$$

$${𝒬}_{P} = Im \{ {V}_{P} {I}_{P}^{*} \} ,$$

$${𝒬}_{S} = Im \{ {V}_{S} {I}_{s}^{*} \}$$

The real power P_{PS} flowing from the primary side to the secondary side can be estimated by (18), since I_{S1} is significantly larger than I_{S2}.

$${P}_{PS} \approx ω M \vert {I}_{P} \vert \vert {I}_{S} \vert sin θ \approx ω M \frac{{V}_{S}}{ω M} \frac{{V}_{P}}{ω M} sin θ = \frac{{V}_{P} {V}_{S}}{ω M} sin θ \qquad ( 18 )$$

When 0 is 90 degrees, the reactive power of the primary side Qₚ is zero, and the reactive power of the secondary side Qₛ is shown in (19).

$${𝒬}_{S} = Im \{ {V}_{S} {I}_{S}^{5} \} = Im \{ {V}_{S} ( {I}_{S 1}^{*} + {I}_{S 2}^{*} ) \} = Im \{ {V}_{S} {I}_{S 2}^{*} \} = \frac{{V}_{S}^{2}}{{( ω M )}^{2} / ω {L}_{P}} \qquad ( 19 )$$

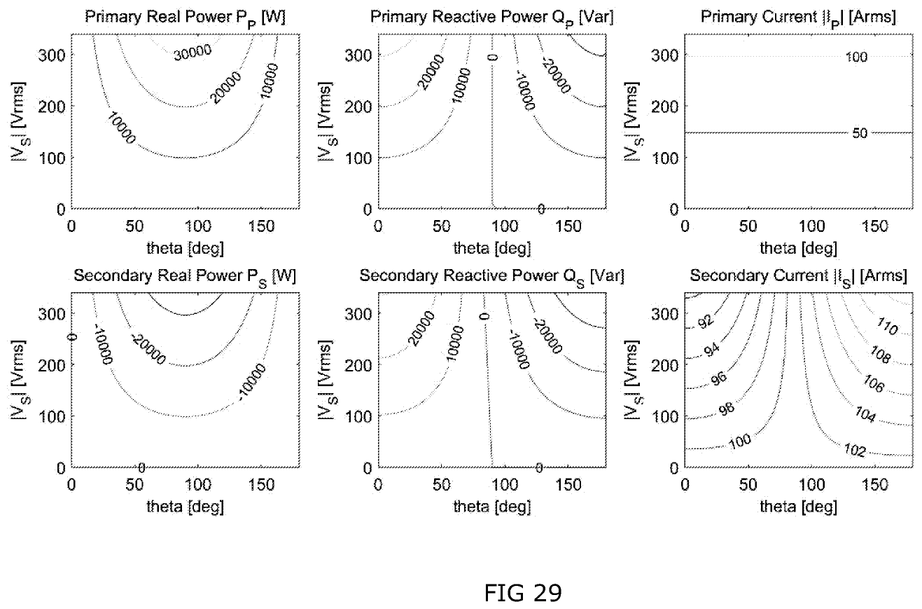

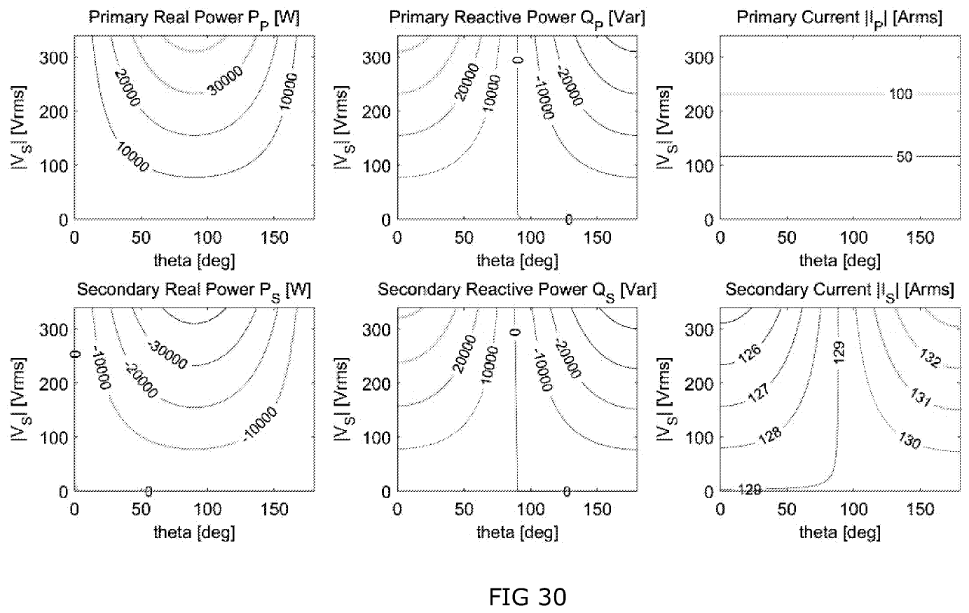

The accurate numerical solution for the real powers, the reactive powers, and currents are shown in FIG. 29 and FIG. 30 for two different cases (Sim 1 and Sim 4). The simulation parameters of four cases with various operating frequencies and RX turns are listed in Table 6.

TABLE 6
Simulation parameters (Foil TX conductor)

| Item | Symbol | Sim 1 | Sim 2 | Sim 3 | Sim 4 |
|---|---|---|---|---|---|
| Frequency | f [kHz] | 85 | 20 | 20 | 20 |
| TX coil parallel turns | N_{TX} | 1 | 1 | 1 | 1 |
| RX coil turns | N_{RX} | 30 | 30 | 70 | 100 |
| Mutual inductance | M [uH] | 5.5500 | 5.5500 | 12.9500 | 18.5000 |
| Inductance of TX coil | Lₚ [uH] | 0.5600 | 0.5600 | 0.5600 | 0.5600 |
| Inductance of RX coil | Lₛ [uH] | 787.50 | 787.50 | 4287.5 | 8750 |
| Capacitor of | Cₛ [nF] | 4.4520 | 80.414 | 14.7699 | 7.2372 |
| secondary side | | | | | |
| Voltage source of | V_{P} [Vrms] | 300 | 300 | 300 | 300 |
| primary side | | | | | |
| DC voltage of the | V_{DC} [V] | 380 | 380 | 380 | 380 |
| battery | | | | | |

In FIG. 29 and FIG. 30, the point with real power Pp of 30 KW and minimum magnitude of Vₛ is chosen as the operation point. For each simulation, the reactive power and current values at the operation point are listed in Table 7.

TABLE 7
The operation point data (Foil TX conductor)

| | | Sim 1 | Sim 2 | Sim 3 | Sim 4 |
|---|---|---|---|---|---|
| | | (85 kHz, | (20 kHz, | (20 kHz, | (20 kHz, |
| Item | Symbol | 30 t) | 30 t) | 70 t) | 100 t) |
| V_{S} magnitude at the | /V_{S}/ [Vrms] | 300 | 70 | 170 | 240 |
| operation point | | | | | |
| V_{S} phase angle at the | θ [deg] | 90 | 90 | 90 | 90 |
| operation point | | | | | |
| Real power flows out | P_{P} [W] | 30363 | 30110 | 31339 | 30970 |
| of V_{P} | | | | | |
| Real power flows out | P_{S} [W] | −30363 | −30110 | −31339 | −30970 |
| of V_{S} | | | | | |
| Reactive power flows | Q_{P} [Var] | 1.8e−12 | 1.8e−12 | 1.9e−12 | 1.9e−12 |
| out of V_{P} | | | | | |
| Reactive power flows | Q_{S} [Var] | −3063 | −708 | −767 | −749 |
| out of V_{S} | | | | | |
| RMS value of the | /I_{P}/ [Arms] | 101 | 100 | 104 | 103 |
| primary current | | | | | |
| RMS value of the | /I_{S}/ [Arms] | 101 | 430 | 184 | 129 |
| secondary current | | | | | |

It can be seen from Table 7, from sim 1 to sim 2, when the frequency is reduced from 85 kHz to 20 KHz, it leads to a smaller Qₛ, and a significantly larger Iₛ.

From sim 2 to sim 3 and sim 4, the turns of RX coil are increased from 30 turns to 70 and 100 turns at a frequency of 20 kHz. The increase of turns brings to a larger mutual inductance, which reduces the secondary current while keeping the Qₛ unchanging.

An analytical analysis has been shown to verify the results above i.e.:
(1) The reduction in frequency leads to a smaller Qₛ, and a significantly larger |I_{S}|.
(2) The increasing mutual inductance reduces |I_{S}| while keeping the Qₛ unchanging.

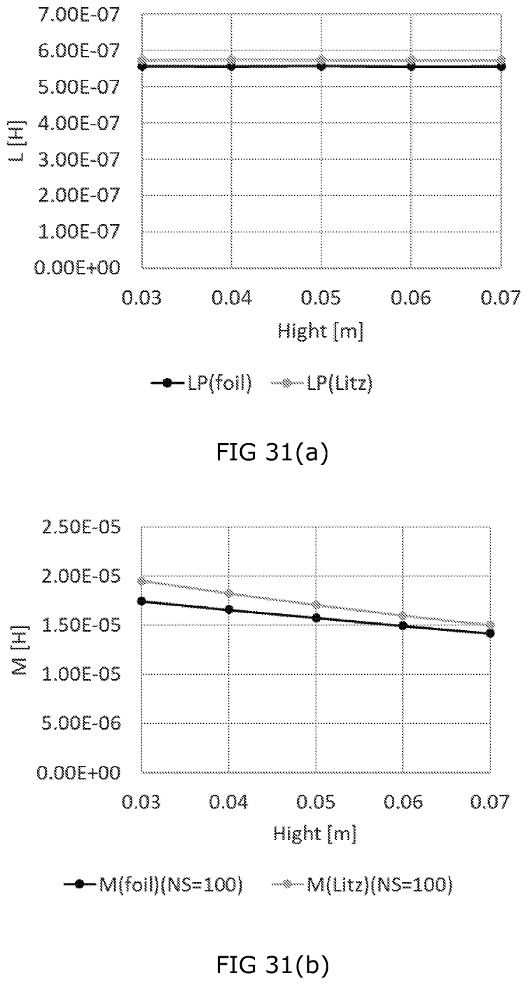

FIGS. 31(a) and 31(b) show the variation of the primary self-inductance and the mutual inductance of Design 1 and Design 3 with different heights of the secondary above the primary. As can be seen, the self-inductance remains constant, while the mutual inductance reduces with the increasing height.

In order to compare the |I_{P}|, |I_{S}|, Q_{P}, Qₛ of the foil and Litz TX conductor structures, a calculation is applied based on the parameters in Table 8. The frequency is 20 kHz. The required power is 2 kW. The primary and secondary voltage, Vₚ and Vₛ, are controlled at the same level to make sure that I_{P} and Iₛ have the same amplitude. 0 is 90 degrees.

TABLE 8
Simulation parameters (foil TX conductor and Litz TX conductor)

| | Foil TX conductor | Litz TX conductor |
|---|---|---|
| Frequency f [kHz] | 20 | 20 |
| Transferred Power P_{P} [W] | 2000 | 2000 |

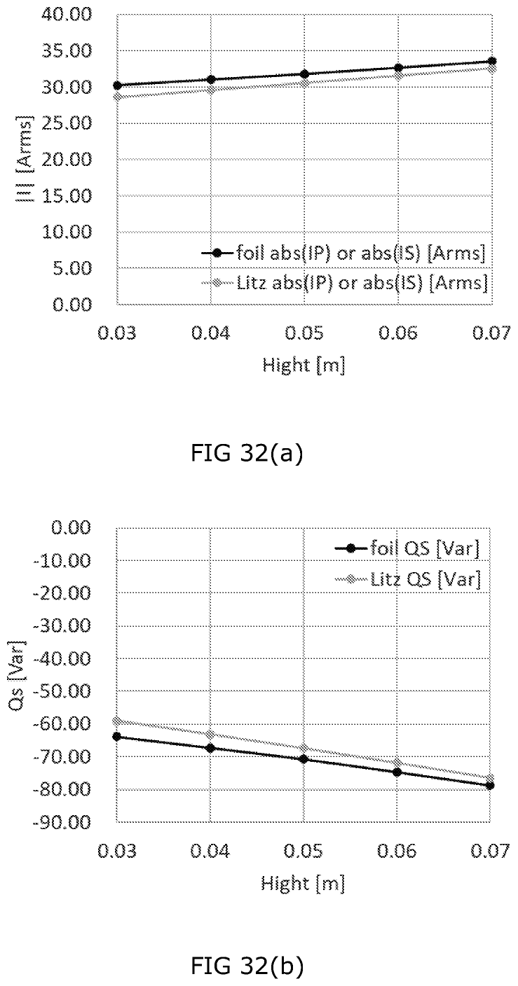

The primary reactive power Qₚ is zero, according to the analysis above. The variation of the current amplitude |I_{P}| or |I_{S}| and the reactive power Qₛ are shown in FIGS. 32(a) and 32(b). As can be seen, the current amplitude and Qₛ increase with the increasing height.

As the primary self-inductance Lₚ and the mutual inductance M of Design 3 with paralleled Litz transmitter is larger than Design 1 with the foil conductor transmitter, |I_{P}| or |I_{S}| of Design 3 is relatively smaller and its Qₛ is also smaller.

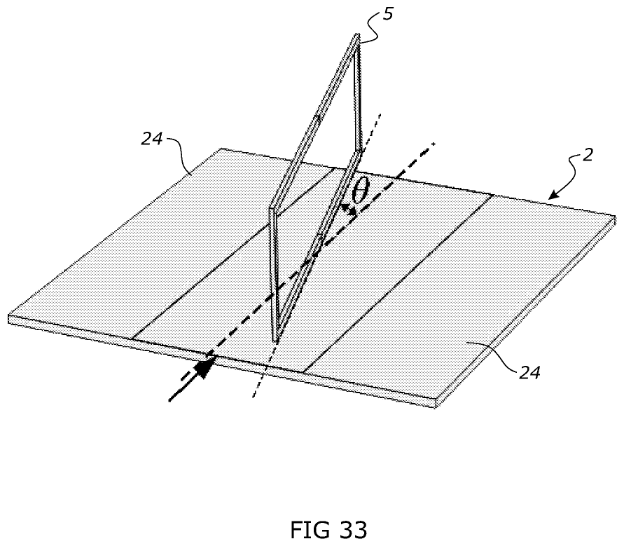

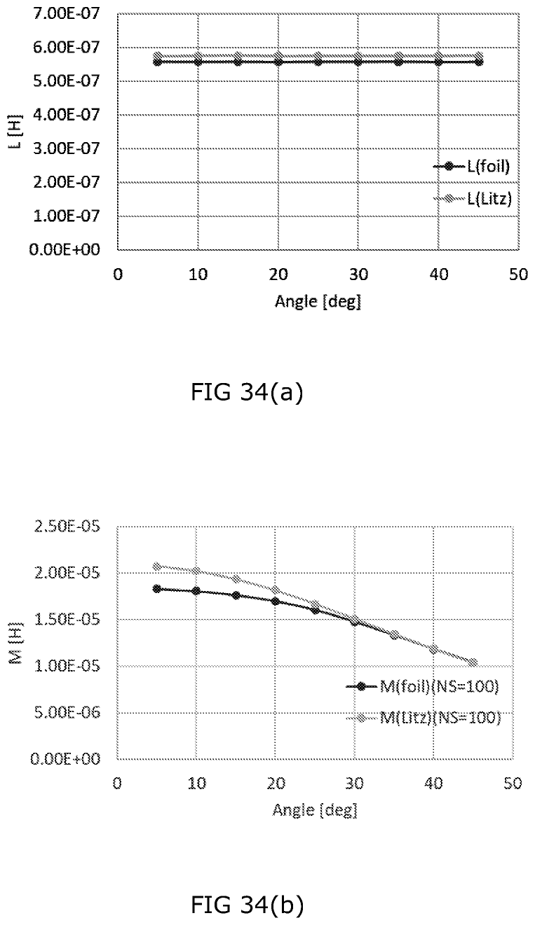

FIGS. 34(a) and 34(b) show the variation of the primary self-inductance and the mutual inductance of Design 1 and Design 3 with different angles theta (which is shown in FIG. 33). As can be seen, the self-inductance remains constant, while the mutual inductance reduces with the increasing angle. In order to compare the |I_{P}|, |I_{S}|, Q_{P}, Qₛ of the foil and Litz TX coil structures, a calculation is applied based on the parameters in Table 9. The frequency is 20 kHz. The required power is 2 kW. The primary and secondary voltage, Vₚ and Vₛ, are controlled at the same level to make sure that I_{P} and I_{S} have the same amplitude. 0 is 90 degrees.

TABLE 9
Simulation parameters (foil TX coil and Litz TX coil)

| | Foil TX coil | Litz TX coil |
|---|---|---|
| Frequency f [kHz] | 20 | 20 |
| Transferred Power P_{P} [W] | 2000 | 2000 |

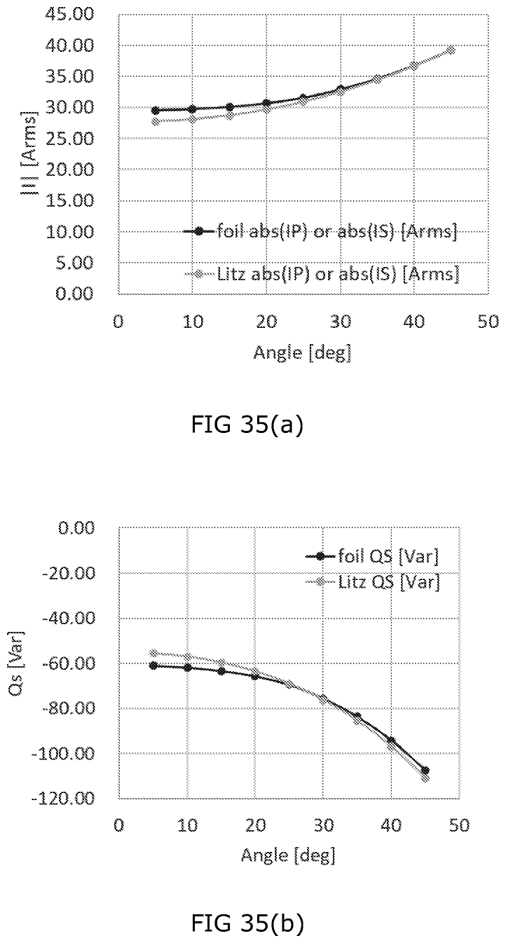

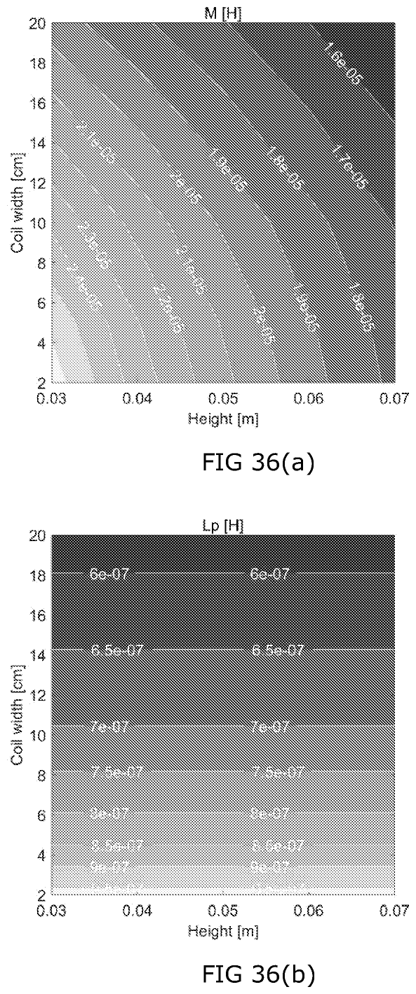

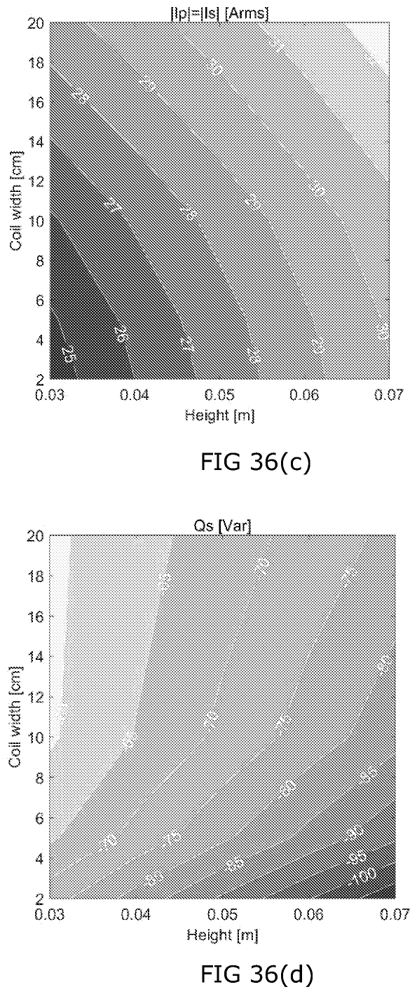

The primary reactive power Qₚ is zero, according to the analysis above. The variation of the current amplitude |I_{P}| or |I_{S}| and the reactive power Qₛ are shown in FIG. 35 (a) and FIG. 35 (b). As can be seen, the current amplitude and Qₛ increase with the increasing angle.

As the primary self-inductance Lₚ and the mutual inductance M of Design 3 with paralleled Litz transmitter is larger than Design 1 with foil coil, |I_{P}| or |I_{S}| of Design 3 is relatively smaller. For small angle, Qₛ of Litz coil is smaller, while Qₛ of Litz coil is larger when angle is large.

Figures show how self-inductance, mutual inductance, current and Qₛ vary with primary TX conductor width and the height of the secondary from the TX conductor for Design 3, based on the parameters shown in Table 10.

TABLE 10
Simulation parameters (Litz TX coil)

| | Litz TX coil |
|---|---|
| Frequency f [kHz] | 20-85, (100-25) |
| Transferred Power P_{P} [W] | 2000 |

Designs 1 and 2 have been compared to a known commonly used IPT system having flat circular primary and secondary coils i.e. having at least a primary of TX coil that has return windings. The parameters of such a system are listed in Table 10, alongside the corresponding parameters of Design 1 and Design 3 for comparison.

TABLE 10
Simulation parameters (foil TX coil and circular TX coil)

| | | Litz TX conductor | |
|---|---|---|---|
| | foil TX conductor | (Np = 40 (parallel), | circular TX coil |
| | (N_{P} = 1, N_{S} = 100) | Ns = 100) | (N_{P} = N_{S} = 26) |
| Frequency f [kHz] | 20 | 20 | 20 |
| M [uH] | 18.5 | 21 | 77 |
| L_{P} [uH] | 0.56 | 0.58 | 543 |
| L_{S} [uH] | 8750 | 8025 | 543 |
| /V_{P}/ [Vrms] | 68.2 | 72.7 | 139.2 |
| /V_{S}\| [Vrms] | 68.2 | 72.7 | 139.2 |
| 0 [deg] | 90 | 90 | 90 |
| \|I_{P}\| [Arms] | 29.3 | 27.5 | 14.4 |
| \|I_{S}\| [Arms] | 29.3 | 27.5 | 14.4 |
| P_{P} [W] | 2000 | 2002.8 | 2002.5 |
| Q_{P} [Var] | −60.6 | −55.1 | 0 |
| P_{S} [W] | −2000 | −2002.8 | −2002.5 |
| Q_{S} [Var] | 0 | 0 | 0 |

It can be seen from Table 10 that the foil TX conductor structure requires larger energizing current since the mutual inductance M is less than that of the common (i.e. circular) design. Although the foil TX conductor structure requires larger currents |I_{P}| and |I_{S}|, the reactive power Qₛ exchanged in the secondary side is small since the primary inductance Lₚ is small.

The output power and the power loss in coils for Design 3 can be determined from the following:

$${P}_{output} = {I}_{P} {I}_{S} ω {N}_{S} {M}^{′} \qquad ( 20 )$$

$${P}_{coil , P} = {{N}_{P} ( {I}_{P}^{′} )}^{2} {R}_{P}^{′} = {{N}_{P} ( \frac{{I}_{P}}{{N}_{P}} )}^{2} {R}_{P}^{′} = \frac{1}{{N}_{P}} {I}_{P}^{2} {R}_{P}^{′}$$

$${P}_{coil , S} = {{N}_{S} ( {I}_{S}^{′} )}^{2} {R}_{S}^{′} = {{N}_{S} ( {I}_{S} )}^{2} {R}_{S}^{′} = {N}_{S} {I}_{S}^{2} {R}_{S}^{′}$$

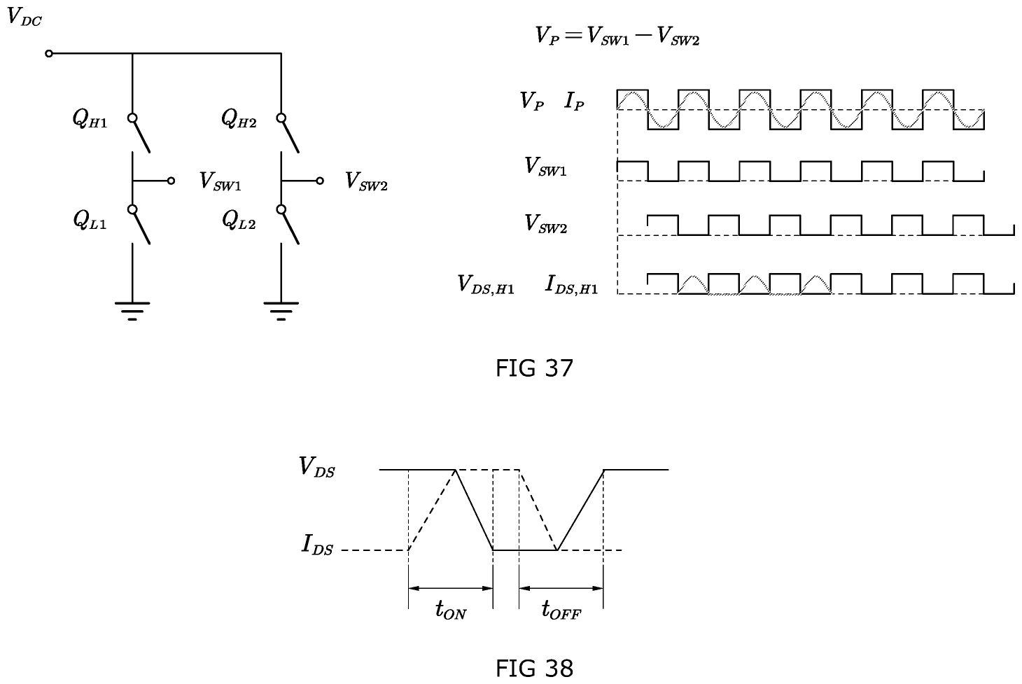

The power loss in converters can also be determined (refer to FIGS. 37 and 38):

$${P}_{cond} = {I}^{2} {R}_{on} D \qquad ( 21 )$$

$${P}_{sw} = \frac{1}{2} {V}_{DS} {I}_{DS} ( {t}_{on} + {t}_{off} ) f$$

$${P}_{conv , P} = 4 ( {P}_{cond , P} + {P}_{sw , P} ) = 4 ( {I}_{P}^{2} {R}_{on} {D}_{P} + \frac{1}{2} ( {V}_{DC , P} ) ( \sqrt{2} {I}_{P} ) ( {t}_{on} + {t}_{off} ) f )$$

$${P}_{conv , S} = 4 ( {P}_{cond , S} + {P}_{sw , S} ) = 4 ( {I}_{S}^{2} {R}_{on} {D}_{S} + \frac{1}{2} ( {V}_{DC , S} ) ( \sqrt{2} {I}_{S} ) ( {t}_{on} + {t}_{off} ) f )$$

The parameters relating to the loss calculation are shown in Table 11 below:

TABLE 11
Parameters in coil loss calculation

| | | |
|---|---|---|
| The mutual inductance of a RX coil with single turn | M′ [uH] | 0.21 |
| The number of parallel conductors in the primary side | N_{P} | 40 |
| The number of parallel conductors in the secondary side | N_{S} | 100, 25 |
| The AC resistance of single conductor in the primary side | R_{P}′ [mOhm] | 0.67966 |
| The AC resistance of single conductor in the secondary | R_{S}′ [mOhm] | 1.9 |
| side | | |

Parameters in converter loss calculation

| | | |
|---|---|---|
| The current duty cycle | D | 0.5 |
| The operation frequency | f [kHz] | 20, 85 |
| The conduction resistance of switch (IPW65R080CFD) | R_{ON} [mOhm] | 80 |
| The switch-on time (IPW65R080CFD) | t_{ON} [ns] | 38 |
| The switch-off time (IPW65R080CFD) | t_{OFF} [ns] | 91 |
| The DC voltage of the primary side | V_{DC, P} [V] | 380 |
| The DC voltage of the secondary side | V_{DC, S} [V] | 380 |

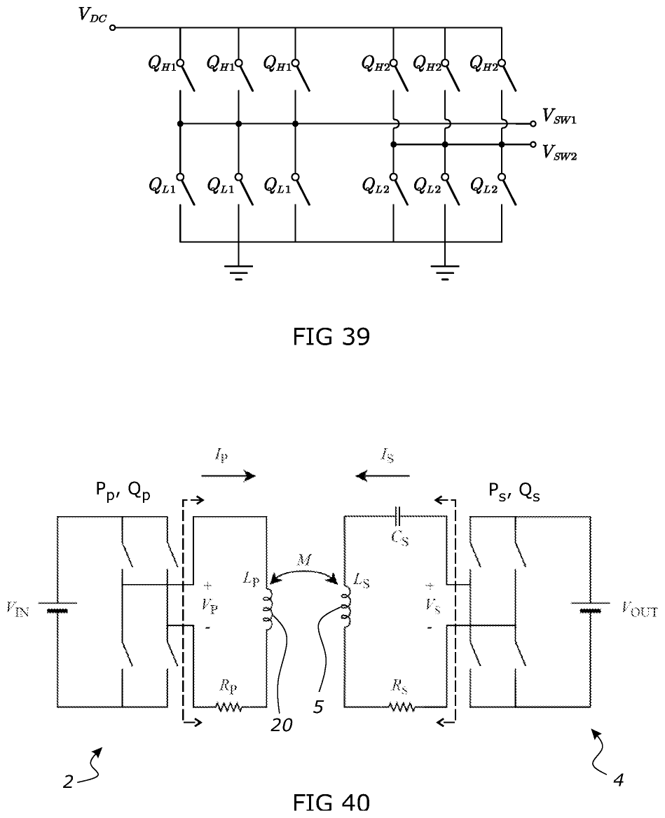

An N-parallel converter module in which one or more additional switches are provided in parallel in one or more legs of the converter, as shown for example in FIG. 39, has been found to reduce switching losses:

Assuming there are N converter modules connected in parallel, the conduction loss and the switching loss in each switch can be calculated as:

$${P}_{cond} = {I}^{2} {R}_{on} D \qquad ( 22 )$$

$${P}_{sw} = \frac{1}{2} {V}_{DS} {I}_{DS} ( {t}_{on} + {t}_{off} ) f$$

$${P}_{conv , P} = 4 N ( {P}_{cond , P} + {P}_{sw , P} ) = 4 N [ {( \frac{{I}_{P}}{N} )}^{2} {R}_{on} {D}_{P} + \frac{1}{2} ( {V}_{DC , P} ) ( \sqrt{2} \frac{{I}_{P}}{N} ) ( {t}_{on} + {t}_{off} ) f ] = ( \frac{4}{N} {P}_{cond , P}^{′} + 4 {P}_{sw , P}^{′} )$$

It can be seen that N-parallel module can reduce the conduction loss and reduce the current stress, keeping the switching loss unchanged. Therefore, an IPW65R080CFD MOSFET may for example be applied in a high power level application by considering or employing the parallel connection.

As set forth earlier in this document, the relatively low inductance of the transmitter coupling structures allows for systems with no primary side compensation. A simple, cost-effective and advantageous compensation arrangement is shown in FIG. 40, in which a secondary-side compensation topology is introduced. There is only one series capacitor Cₛ on the secondary side, while there is no compensating capacitor on the primary side. Two specific operation or control cases are discussed below, to help decrease the VA rating of the source.

The system of FIG. 40 may be represented mathematically as:

$$[ \begin{matrix}{V}_{P} \\ {V}_{S}\end{matrix} ] = [ \begin{matrix}{R}_{P} + {jX}_{P} & {jX}_{M} \\ {jX}_{M} & {R}_{S} + {jX}_{SC}\end{matrix} ] [ \begin{matrix}{I}_{P} \\ {I}_{S}\end{matrix} ]$$

It is assumed that the inductive reactance of L_{P} and L_{S} are Xₚ=ωLₚ and Xₛ=ωLₛ. When Lₛ is compensated by the capacitor Cₛ, the total reactance on the secondary side is

$${X}_{SC} = ω {L}_{S} - \frac{1}{ω {C}_{S}} .$$

For the operational case 1, Xs is fully compensated by the capacitor Cₛ, and it is assumed that there is no reactive power provided by the secondary source. The condition can be expressed as:

$$\{ \begin{matrix}{X}_{P} \neq 0 \\ {X}_{SC} = 0\end{matrix}$$

$$and$$

$$\{ \begin{matrix}{Q}_{P} \neq 0 \\ {Q}_{S} = 0\end{matrix} .$$

The angle θ between Vₚ and Vₛ can be solved as:

$$θ = arccos ( \frac{{X}_{P}}{{X}_{M}} \frac{{V}_{S}}{{V}_{P}} )$$

The output active and reactive power are:

$${P}_{P} = - {P}_{S} = \frac{1}{{X}_{M}} {V}_{P} {V}_{S} sin θ$$

$${Q}_{P} = \frac{{X}_{P}}{{X}_{M}^{2}} {V}_{S}^{2}$$

$${Q}_{S} = 0$$

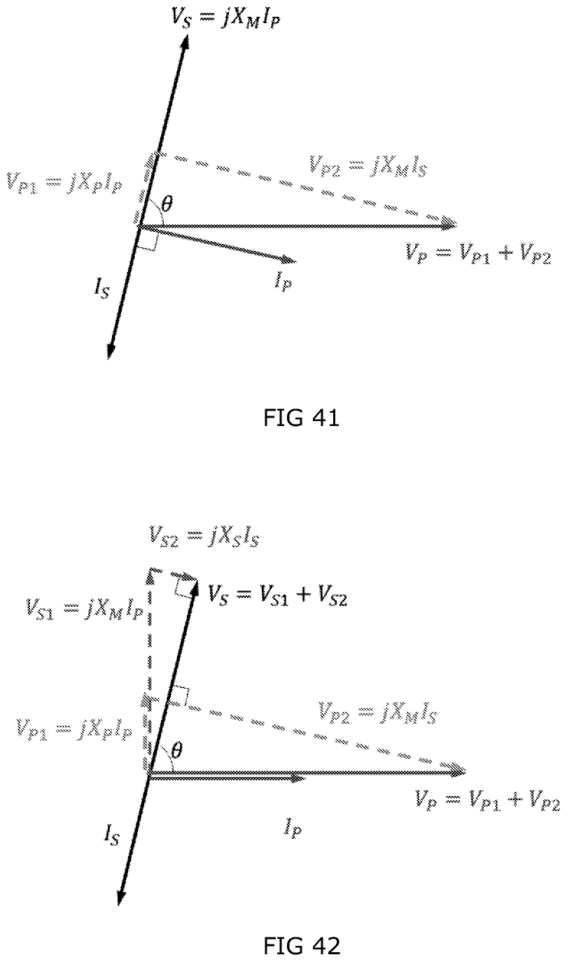

The vector or phasor diagram for the voltage and current on the primary and secondary sides are shown in FIG. 41.

The active power can be controlled by regulating Vₚ and Vₛ, while keeping e constant to make the reactive power Qₛ zero. However, as the output power demand increases, the reactive power Qₚ on the primary side also increases, which increases the requirement for the VA rating of the primary source.

For operational case 2, Xp is fully compensated by the reflected impedance, and Xs is partially compensated by Cₛ but there is no reactive power provided by the secondary source. The condition can be expressed as:

$$\{ \begin{matrix}{X}_{P} \neq 0 \\ {X}_{SC} = 0\end{matrix}$$

$$and$$

$$\{ \begin{matrix}{Q}_{P} \neq 0 \\ {Q}_{S} = 0\end{matrix}$$

The angle θ and the compensation ratio

$${N}_{X} = \frac{{X}_{SC}}{{X}_{S}} ,$$

where k is the coupling coefficient between TX and RX coils are given by:

$$θ = arccos ( \frac{{X}_{P}}{{X}_{M}} \frac{{V}_{S}}{{V}_{P}} )$$

$${N}_{X} = {k}^{2} {cos}^{2} θ$$

The reactance XSC on the secondary side is:

$${X}_{SC} = {X}_{P} \frac{{V}_{S}^{2}}{{V}_{P}^{2}}$$

The output active and reactive power are:

$${P}_{P} = \frac{1}{{X}_{M}} {V}_{P} {V}_{S} \frac{1}{sin θ}$$

$${Q}_{P} = 0$$

$${Q}_{S} = 0$$

The vector or phasor diagram for the voltage and current on the primary and secondary sides for case 2 are shown in FIG. 42.

For the given 0 and Nₓ defined in case 2, the active power can be controlled by regulating Vₚ and Vₛ. By operating under the conditions of case 2, Qₚ and Qₛ are kept zero, which will help to decrease the demand for high VA rating of sources compared to case 1.

For the case of conventional series-series (S-S) compensation, Xp and Xs are fully compensated by series capacitors Cₚ and Cₛ respectively, and there is no reactive power provided by the primary and secondary sources. The condition can be expressed as

$$\{ \begin{matrix}{X}_{PC} = 0 \\ {X}_{SC} = 0\end{matrix}$$

$$and$$

$$\{ \begin{matrix}{Q}_{P} = 0 \\ {Q}_{S} = 0\end{matrix} ,$$

where

$${X}_{PC} = ω {L}_{P} - \frac{1}{ω {C}_{P}} ,$$

$${X}_{SC} = ω {L}_{S} - \frac{1}{ω {C}_{S}} .$$

The angle θ between Vₚ and Vₛ can be solved as:

$$θ = \frac{π}{2}$$

The output active and reactive power is:

$${P}_{P} = - {P}_{S} = \frac{1}{{X}_{M}} {V}_{P} {V}_{S}$$

$${Q}_{P} = 0$$

$${Q}_{S} = 0$$

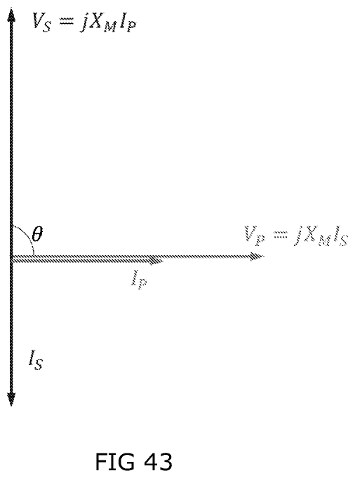

The phasor diagram for the voltage and current on the primary and secondary side is shown in FIG. 43.

With the conventional S-S compensation, the active power can be controlled by regulating Vₚ and Vₛ, and Qₚ and Qₛ are zero when 0 is

$$\frac{π}{2} .$$

However, the convention S-S compensation requires two capacitors Cₚ and Cₛ to make Qₚ and Qₛ zero, which increases the cost of the system.

Comparing case 1 and case 2 it can be seen that 0 required for case 1 and case 2 is the same, which is determined by the ratio of

$$\frac{{V}_{S}}{{V}_{P}} .$$

After selecting 0, the next step is selecting Cₛ so that Xs is compensated to X_{SC}=0 for case 1, while Xs is compensated to

$${X}_{SC} = {X}_{P} \frac{{V}_{S}^{2}}{{V}_{P}^{2}}$$

for case 2.

For case 1, Qₚ.x is only provided by the output reactive power from the voltage source Vₚ. The output reactive power is

$${Q}_{P} = \frac{{X}_{P}}{{X}_{M}^{2}} {V}_{S}^{2}$$

the output active power is

$${P}_{P} = \frac{1}{{X}_{M}} {V}_{P} {V}_{S} sin θ$$

For case 2, X_{P,ref1} has a negative value, and Q_{p,x} is only provided by the reflected reactance X_{P,ref1}. The reactive power

$${Q}_{PX} = \frac{{X}_{P}}{{X}_{M}^{2}} {V}_{S}^{2} \frac{1}{{sin}^{2} θ} .$$

The output reactive power from the voltage source Vp is 0. The output active power is

$${P}_{P} = \frac{1}{{X}_{M}} {V}_{P} {V}_{S} \frac{1}{sin θ} .$$

A calculation can be performed using the parameters shown in Table 12 below.

TABLE 12
The parameters for the calculation.

| Item | Symbol | Value | |
|---|---|---|---|
| frequency | f [kHz] | 85 | |
| inductance of TX coil | L_{P} [uH] | 1.09 | |
| inductance of RX coil | L_{S} [uH] | 527 | |
| mutual inductance | M [uH] | 3.39 | |
| resistance on primary side | R_{P} [mΩ] | 68.10 | |
| resistance on secondary side | R_{S} [mΩ] | 64.00 | |
| compensating capacitor on primary side | C_{P} [uF] | case 1 | none |
| | | case 2 | none |
| | | S-S | 3.2164 |
| compensating capacitor on secondary side | C_{S} [nF] | case 1 | 6.6526 |
| | | case 2 | 6.6664 |
| | | S-S | 6.6526 |
| DC voltage on primary and secondary side | V_{DC} [V] | 350 | |
| modulation ratio on primary side | α | 0.15~0.35 | |
| modulation ratio on secondary side | β | 0.15~0.35 | |
| AC voltage on primary side | V_{P} | αV_{DC} | |
| AC voltage on secondary side | V_{S} | βV_{DC} | |
| phase angle between V_{P} and V_{S} | θ [deg] | case 1 | 50~80 |
| | | case 2 | 50~80 |
| | | S-S | 90 |

In the calculation of case 1 and case 2, Vₚ and Vₛ are chosen as two variables to see the profiles of the power and efficiency. 0 is changed according to the ratio of

$$\frac{V s}{{V}_{P}} .$$

For the design of Cₛ in case 2, to simplify the analysis, it is assumed that

$$\frac{V s}{{V}_{P}} = 1 ,$$

which means adapting Cₛ to other ratios of

$$\frac{V s}{{V}_{P}}$$

is not included in the simulation. In the calculation for S-S compensation topology, Vₚ and Vₛ are also regulated to control the output power, and 0 is kept constant at 90 degrees.

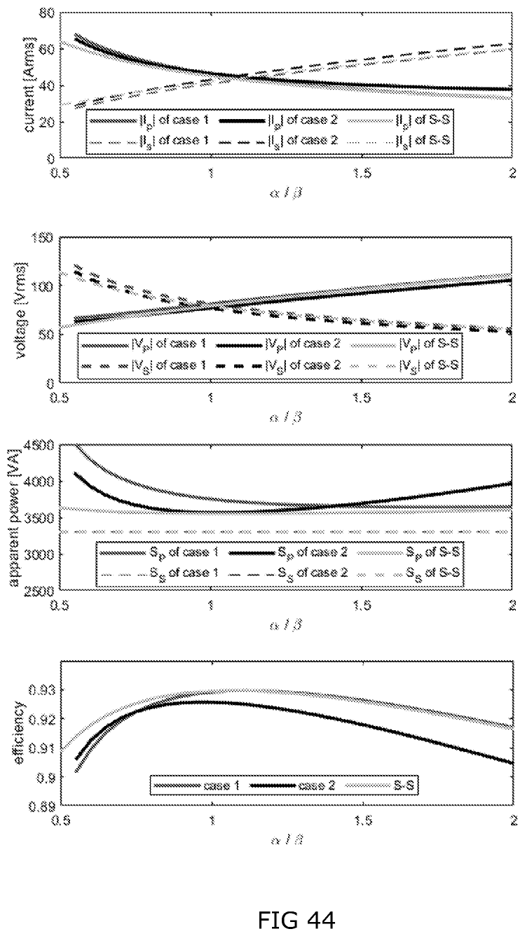

To compare the three cases, a/B is chosen as the variable and the reactive power, power loss, and efficiency are considered along the trajectory of an output power of 3.3 kW, which is shown in FIG. 44.

In FIG. 44, when a/B increases, |Iₚ|, |Vₛ| decrease and |Iₛ|, |Vₚ| increase in three cases.

The maximum efficiency in case 1, case 2, and S-S compensation are 92.97%, 92.57%, and 92.97%, respectively. The most efficient operating points are located close to α/β=1.

At each most efficient operating point, the primary apparent power |Sₚ| is 3730 VA, 3570 VA, and 3549 VA in case 1, case 2, and S-S compensation, respectively. The secondary apparent power |Sₛ| is kept constant at 3.3 kVA in three cases, as it is assumed that there is no reactive power provided by the secondary source.

Comparing case 1 and the S-S compensation, by removing the primary-side compensating capacitor, the cost of the IPT system can be reduced in case 1. However, the reactive power consumed by Lₚ is provided by the primary source, which increases the VA rating of the primary source in case 1.

Comparing case 1 and case 2, by partially compensating Lₛ, the reactive power consumed by Lₚ is only provided by the reflected reactance in case 2. With the most efficient operation, the required |Sₚ| decreases from 3730 VA in case 1 to 3570 VA in case 2, without much loss of efficiency.

Therefore, the proposed operation method in case 2 will help to decrease the VA rating of the source in a cost-efficient IPT system with only secondary-side compensation.

Parameters for the number of wires/cables 50 and the spacing between them for implementing a primary coupler according to Design 3 are now considered.

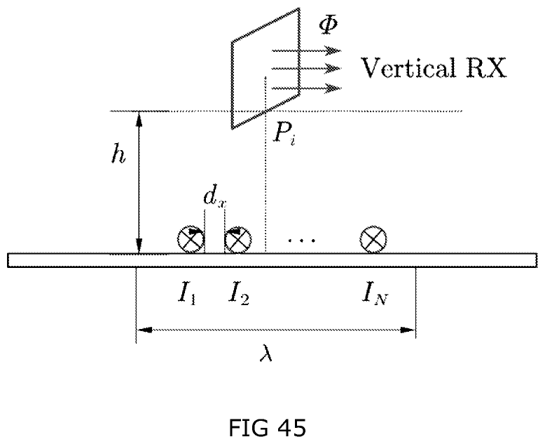

Referring to FIG. 45, the number of wire lengths 50 and the distance between each length can be optimized in one segment for dynamic wireless power transfer (DWPT) to achieve better performance in a comprehensive manner. Thus, the optimization problem can be stated as follows:

Change the number of wire lengths 50 (N) and the distance (d) between each wire length of the primary paralleled Litz wires in one segment A of a DWPT system when the total MMF is constant, to achieve a multi-objective optimization, which includes:
1. Improve the stability of coupling flux ¢ in the RX coil with the lateral displacement x,
2. Improve the magnitude of coupling flux ¢ in the RX coil;
3. Reduce the loss in Litz wires of the TX coil;
4. Reduce the cost of Litz wires of the TX coil.

a. Variables N and d

N: number of the paralleled turns of Litz wires in the primary;

d: distance between the center of each wire length. The value of d is assumed to be identical between any adjacent wire lengths.

b. Optimization objectives

$$1. Minimize CV , CV = \frac{{σ}_{Φ}}{\overline{Φ}} = \frac{\sqrt{\frac{{\sum }_{i = 0}^{m} {( {Φ}_{i} - \overline{Φ} )}^{2}}{m}}}{\overline{Φ}}$$

The symbol σ_{Φ} is the standard deviation of the coupling flux in the vertical RX coil and can measure the uniformity of the magnetic field B distribution and coupling. Φᵢ is the coupled flux at a position Pᵢ in the RX at a height of h, as shown in FIG. 45. The symbol m represents the number of measured positions. The symbol @ is the average magnitude of ø; and can measure the magnitude of coupling. Mirror image is used to calculate the magnetic field of the primary coil fitted with a ferrite plate.

This objective equals to

$$\{ \begin{matrix}Maximize \overline{Φ} \\ Minimize {σ}_{Φ}\end{matrix}$$

simultaneously.

### 2. Minimize Pₗₒₛₛ

The power loss in Litz wires of the TX coil is the sum of losses of all the paralleled lengths, which includes DC loss and AC loss. The AC loss is caused by the skin effect and proximity effect. These losses of Litz wires with a unit length can be calculated according to the equations below.

$${P}_{dc + skin} = N \cdot n \cdot {R}_{dc} \cdot {F}_{R} ( f ) \cdot {( \frac{\hat{I}}{n} )}^{2}$$

$${P}_{prox} = {\sum }_{j = 1}^{N} n \cdot {R}_{dc} \cdot {G}_{R} ( f ) \cdot ( {\hat{H}}_{e}^{2} + \frac{{\hat{I}}^{2}}{2 {π}^{2} {d}_{a}^{2}} )$$

Where j means the jᵢₙ turn of the TX coil. The symbol n is the number of strands in a Litz wire, and Rac is the DC resistance of a single strand in the Litz wire. The parameters FR and GR are factors introduced in the loss model, which are frequency dependent. The symbol da is the diameter of a Litz wire, Î is the peak current in each length, and He is the peak external magnetic field posed by other lengths and should be evaluated at the conductor centers.

Assume the current is evenly distributed in each wire, as the conductor is Litz wire. Thus,

$$I = \frac{{I}_{t}}{N} ,$$

$$\hat{I} = \sqrt{2} I$$

$${P}_{loss} = {P}_{dc + skin} + {P}_{prox}$$

### 3. Minimize the Normalized Cost CN

$${C}_{N} = \frac{N}{{N}_{max}} \cdot {C}_{0}$$

Where Co is the cost per length of Litz wires per unit length, and Nₘₐₓ is the maximum number of the paralleled lengths of Litz wires of the TX coil.

c. Parameter Setting for Optimization

| Item | Symbol | Value |
|---|---|---|
| total current in the TX coil | Iₜ [A] | 50 |
| segment length | λ [m] | 0.2 |
| observation height of Φ | h [m] | 0.01 |
| width of the RX coil | w_{S} [m] | 0.15 |
| length of the RX coil | I_{S} [m] | 1 |
| number of turns of the RX coil | N_{S} | 1 |
| diameter of a Litz wire | dₐ [mm] | 4 |
| number of strands in a Litz wire | n | 1000 |
| maximum number of turns of | Nₘₐₓ | 100 |
| the TX coil | | |
| Distance between lengths | d [m] | 0.002~0.04 |

c. Optimization Method

Parameter sweep is conducted for the two variables N and d in Matlab, according to the parameter setting. Meanwhile, these two variables need to satisfy the equation below to guarantee valid calculation.

$$( N - 1 ) \cdot d \leq λ$$

Values of the three optimization objectives CV, Pₗₒₛₛ, and CN are then obtained for each set of N and d.

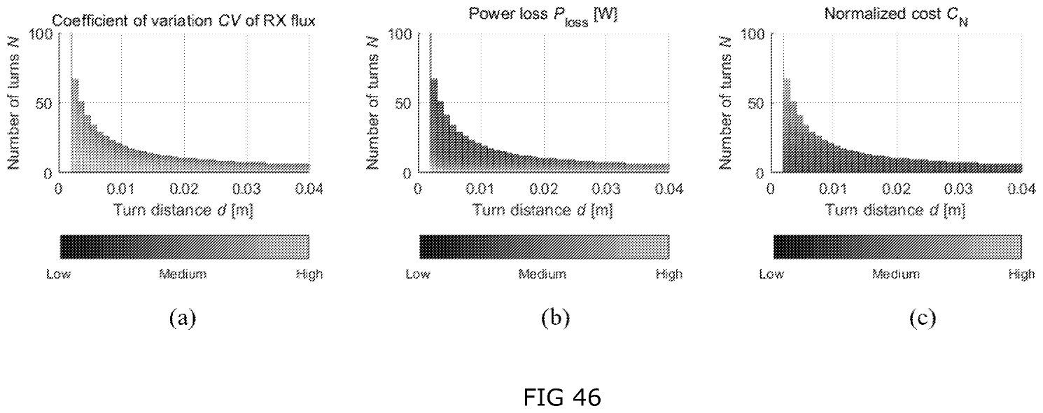

FIG. 46 (a), (b), and (c) give the variation of CV, Pₗₒₛₛ, and CN with N and d, respectively. As can be seen, these three objectives show different variations with N and d. In FIG. 46 (a), for a given distance d, a lower CV can be achieved by increasing the number of lengths N. In FIG. 46 (b), the power loss Pₗₒₛₛ in the TX coil reduces with the increasing N, as the current in each length is becoming smaller. However, increasing N will increase the cost CN as shown in FIG. 46 (c).

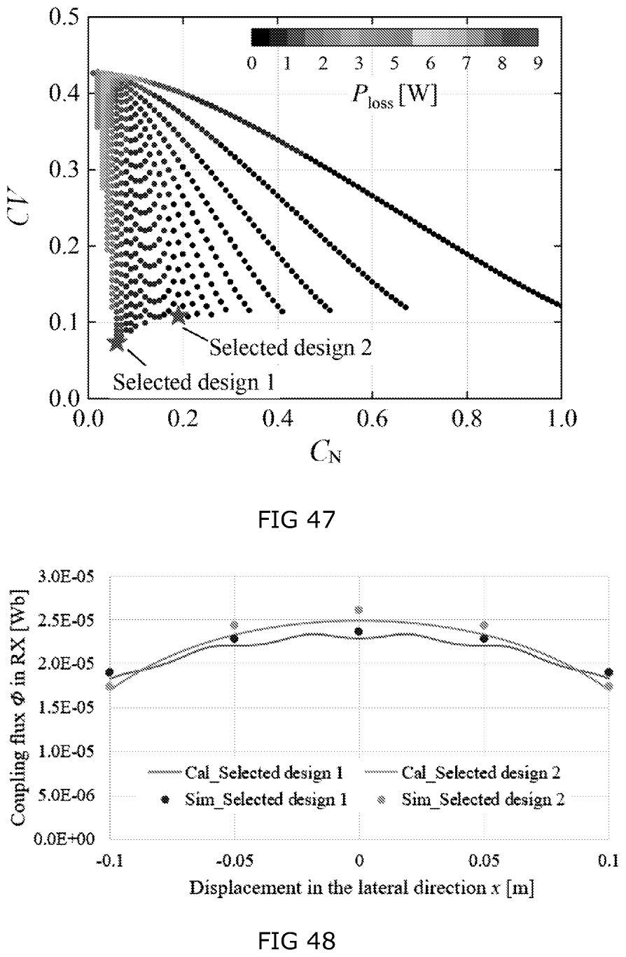

In order to determine the optimum design, FIG. 47 gives the variation of the three objectives CV, Plos, and CN with each other. The color bar indicates the variation of power loss. Each point in FIG. 47 indicates a design with specific N and d. As can be seen, when CN decreases and CV is kept identical, Pₗₒₛₛ increases. When CV decreases and CN is kept identical, Pₗₒₛₛ has slight variation.

Though the design with the least CV, Pₗₒₛₛ, and CN is desired, the three objectives cannot be achieved simultaneously according to FIG. 47. Therefore, two designs with relatively low objectives are selected in FIG. 47, which are represented by red stars. Their performance is compared to determine the optimum solution.

The number of turns and turn distances of the two selected designs and their corresponding objectives are given in Table 13. The selected design 1 has lower CN and CV and a relatively higher loss compared to the selected design 2.

TABLE 13
Performance of the selected designs.

| | | Selected | Selected |
|---|---|---|---|
| Item | Symbol | design 1 | design 2 |
| number of lengths of | N | 6 | 19 |
| the TX coil | | | |
| distance between | d [m] | 0.04 | 0.011 |
| lengths | | | |
| coefficient of variation | CV | 0.07 | 0.11 |
| power loss | Pₗₒₛₛ [W] | 1.45 | 0.48 |
| normalized cost | C_{N} | 0.06 | 0.19 |

The variation of coupling flux in the RX coil of the two selected designs with lateral displacement x is shown in FIG. 48. The coupling flux in design 2 is generally higher than in design 1, however, with relatively lower stability and a much higher number of lengths.

Considering that the selected design 1 has only one-third of the cost compared to design 2, the selected design 1 can be chosen as the optimum design. Design 1 has spacings of up to 10 wire diameters between wires, with 6 lengths. Design 2 has spacings of 2-4 wire diameters between wires. Variations of the high performing designs above are possible. For example, a primary or transmitter structure according to Design 3 may have a 5 to 10 lengths 50 with a range of 0.2-. 06 m between lengths, or 15-25 lengths with a spacing of 0.08 to 0.015 m therebetween.

2D simulations conducted for the selected designs in COMSOL are shown in FIG. 48 which agrees with the foregoing conclusions.

It can be seen that a novel transmitter together with a vertical Litz receiver is provided that achieves stable and effective inductive coupling for a number of applications, one of which includes dynamic EV charging. Either flat ferrite plate or U-shaped ferrite can be added to the transmitter to enhance the performance, while the receiver can be air-cored. The flux density distribution and coupled flux in the receiver shows that the proposed arrangement can improve upon existing designs regarding the coupling performance, weight, and cost on the receiver side.

Throughout the description like reference numerals are used to refer to like features in different embodiments. It will be understood that the primary or secondary couplers described herein may be interchanged i.e. the primary may be used as a secondary or vice versa, and in a bidirectional system the primary and secondary couplers will effectively be interchanged dependent on the direction in which power is being transferred.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Although this invention has been described by way of example and with reference to possible embodiments thereof, it is to be understood that modifications or improvements may be made thereto without departing from the scope of the invention. The invention may also be said broadly to consist in the parts, elements and features referred to or indicated in the specification of the application, individually or collectively, in any or all combinations of two or more of said parts, elements or features. Furthermore, where reference has been made to specific components or integers of the invention having known equivalents, then such equivalents are herein incorporated as if individually set forth.

Any discussion of the prior art throughout the specification should in no way be considered as an admission that such prior art is widely known or forms part of common general knowledge in the field.

1-18. (canceled)

19. A wireless power transmitting coupling apparatus comprising:
a non-looped conductive layer adapted to be arranged rearwardly from and facing toward a wireless power receiving coupling apparatus, and configured to conduct an input current across opposite ends of the conductive layer along a first planar direction to generate a magnetic field; and
a magnetically permeable guide layer arranged rearwardly from and facing toward the conductive layer, and configured to guide the generated magnetic field forwardly and across opposite outer peripheral edges of the conductive layer along a second planar direction perpendicular to the first planar direction to power the wireless power receiving coupling apparatus.

20. The wireless power transmitting coupling apparatus of claim 19, wherein the layers are substantially square or rectangular in shape, whereby the guided magnetic field represents a flux tube with a uniform width along the second planar direction.

21. The wireless power transmitting coupling apparatus of claim 19, comprising no other conductive layer forming a capacitance with the conductive layer.

22. The wireless power transmitting coupling apparatus of claim 19, further comprising:
two terminals provided respectively at the opposite ends of the conductive member and adapted to receive power to provide the input current, wherein the electrical terminals match the respective ends in dimension along the second planar direction.

23. The wireless power transmitting coupling apparatus of claim 19, wherein the conductive layer comprises a plurality of spaced lengths of wire, with one length placed next to and outside of another.

24. The wireless power transmitting coupling apparatus of claim 23, wherein the wire is solid wire.

25. The wireless power transmitting coupling apparatus of claim 19, wherein the opposite ends of the conductive layer face away from each other.

26. The wireless power transmitting coupling apparatus of claim 19, wherein the conductive layer and the guide layers are planar.

27. The wireless power transmitting coupling apparatus of claim 19, wherein the guide layer has opposite peripheral regions extending beyond respective opposite peripheral edges of the conductive layer along the second planar direction.

28. The wireless power transmitting coupling apparatus of claim 27, further comprising magnetically permeable guide walls extending forwardly from respective ones of the peripheral regions of the guide layer.

29. The wireless power transmitting coupling apparatus of claim 28, wherein the walls extend forwardly beyond the conductive layer.

30. The wireless power transmitting coupling apparatus of claim 19, wherein the conductive layer comprises a foil.

31. The wireless power transmitting coupling apparatus of claim 19, further comprising:
a magnetic shielding layer arranged rearwardly from and facing toward the guide layer to shield the guided magnetic field.

32. The wireless power transmitting coupling apparatus of claim 19, wherein the guide layer corresponds substantially in shape to the conductive layer.

33. A system comprising:
the wireless power transmitting coupling apparatus of claim 19; and
a wireless power receiving coupling apparatus associated with the wireless power transmitting coupling apparatus, wherein the wireless power receiving coupling apparatus comprises a plurality of coil segments extending between two planes parallel to the conductive layer, arranged about and extending along an axis perpendicular to the planes, and oriented in different radial directions with respect to the axis.

34. A system comprising:
the wireless power transmitting coupling apparatus of claim 19; and
a wireless power receiving coupling apparatus associated with the wireless power transmitting coupling apparatus, wherein the wireless power receiving coupling apparatus comprises:
a further conductive layer arranged forwardly from and facing toward the conductive layer of the wireless power transmitting coupling apparatus, and configured to be exposed to the magnetic field to conduct an output current across opposite ends of the further conductive layer along the first planar direction; and
a magnetically permeable further guide layer associated with the further conductive layer, and adapted to further guide the guided magnetic field toward the further conductive layer and across the further conductive layer along the second planar direction.

35. A system comprising:
the wireless power transmitting coupling apparatus of claim 19; and
a wireless power receiving coupling apparatus associated with the wireless power transmitting coupling apparatus, wherein the wireless power receiving coupling apparatus comprises:
a further conductive layer configured to be exposed to the magnetic field to conduct an output current across opposite ends of the further conductive layer along the first planar direction; and
a movement mechanism operable to move the further conductive layer relative to the wireless power transmitting coupling apparatus so that an exposure of the further conductive layer to the magnetic field increases.

36. A system comprising:
a wireless power receiving coupling apparatus comprising a secondary side capacitor and a secondary coupler connected with and configured to be partially compensated by the secondary side capacitor; and
the wireless power transmitting coupling apparatus of claim 19 associated with the receiving coupling apparatus and comprising a primary coupler configured with a reactance to be fully compensated by a reflectance of a residual reactance of the partially compensated secondary coupler,
wherein the system complies with:
$$θ = arccos ( \frac{{X}_{P} {V}_{S}}{{X}_{M} {V}_{P}} )$$
where ‘Vₚ’ represents a voltage of the primary coupler, ‘Vₛ’ represents a voltage of the secondary coupler and the secondary-side capacitor, ‘Xp’ represents a reactance of the primary coupler, ‘Xs’ represents a reactance of the secondary coupler, and ‘0’ represents a phase angle between Vₚ and Vₛ; and
$${C}_{S} = \frac{1}{ω ( ω {L}_{S} - ω {L}_{P} \frac{{V}_{S}^{2}}{{V}_{P}^{2}} )}$$
where ‘Cₛ’ represents a capacitance of the secondary-side capacitor, ‘@’ represents an operating frequency of the IPT system, ‘Lₚ’ represents an inductance of the primary coupler, and ‘Lₛ’ represents an inductance of the secondary coupler.

37. A wireless power receiving coupling apparatus comprising a plurality of coil segments which are adapted to extend between two planes parallel to a conductive layer of a wireless power transmitting coupling apparatus, which are adapted to be arranged about and extending along an axis perpendicular to the planes, and which are adapted to be oriented in different radial directions with respect to the axis.

38. A wireless power receiving coupling apparatus comprising:
a conductive layer adapted to be arranged forwardly from and facing toward a conductive layer of a wireless power transmitting coupling apparatus, and configured to be exposed to a magnetic field of the transmitting coupling apparatus to conduct an output current across opposite ends of the conductive layer along a first planar direction; and
a magnetically permeable guide layer associated with the conductive layer, and adapted to guide the magnetic field toward the conductive layer and across the conductive layer along a second planar direction perpendicular to the first planar direction.
